(19) United States
(12) Patent Application Publication
(10) Pub. No.: US 2020/0092550 A1
(43) Pub. Date: Mar. 19, 2020

(54) METHOD AND DEVICE FOR FILTERING REFERENCE SAMPLE IN INTRA-PREDICTION

(71) Applicant: SAMSUNG ELECTRONICS CO., LTD., Suwon-si (KR)

(72) Inventor: Yin-ji PIAO, Yongin-si (KR)

(73) Assignee: SAMSUNG ELECTRONICS CO., LTD., Suwon-si (KR)

(21) Appl. No.: 16/467,349

(22) PCT Filed: Dec. 22, 2017
(86) PCT No.: PCT/KR2017/015328

§ 371 Date: Jun. 6, 2019

Related U.S. Application Data
(60) Provisional application No. 62/439,175, filed on Dec. 27, 2016.

(51) Int. Cl. H04N 19/117; H04N 19/105; H04N 19/176; H04N 19/543; H04N 19/20

(52) U.S. Cl. CPC H04N 19/117; H04N 19/105; H04N 19/20; H04N 19/543; H04N 19/176

(57) ABSTRACT

The present disclosure relates to a method and device for filtering reference samples in intra-prediction. An encoded bitstream may be received, information regarding an intra-prediction mode of a current block may be obtained from the bitstream, a filter may be determined based on a signal component of the current block, a width and height of the current block, and a value of at least one among reference samples neighboring the current block, filtered reference samples may be produced by applying the filter to the reference samples, and a predicted sample of the current block may be produced based on the filtered reference samples and the intra-prediction mode.

### TECHNICAL FIELD

The present disclosure relates to an image encoding method and device and an image decoding method and device, and more particularly, to a method and device for filtering reference samples in intra-prediction.

### BACKGROUND ART

Image data is encoded by a codec conforming to a predetermined data compression standard, e.g., the Moving Picture Expert Group (MPEG) standard, and then is stored in a recording medium or transmitted through a communication channel in the form of a bitstream.

As hardware capable of reproducing and storing high-resolution or high-quality image content has been developed and become popularized, a codec capable of efficiently encoding or decoding the high-resolution or high-quality image content is in high demand. To reproduce the encoded image content, the image content may be decoded. Currently, methods of effectively compressing the high-resolution or high-quality image content are used.

Various data units may be used for image compression, and a hierarchical structure may be present between the data units. A data unit may be split in various ways to determine the size of a data unit used for image compression, and image encoding or decoding may be performed by determining a data unit optimized for image characteristics.

### DESCRIPTION OF EMBODIMENTS

### Technical Problem

Provided are a method and device for filtering reference samples in intra-prediction, according to various embodiments. Aspects of embodiments are not limited thereto and other aspects may be derived from embodiments which will be described below.

### Solution to Problem

According to an aspect of the present disclosure, an image decoding method includes receiving an encoded bitstream; obtaining information regarding an intra-prediction mode of a current block from the bitstream; determining a filter, based on a signal component of the current block, a width and height of the current block, and a value of at least one among reference samples neighboring the current block; producing filtered reference samples by applying the filter to the reference samples; and producing a predicted sample of the current block, based on the filtered reference samples and the intra-prediction mode.

In one embodiment, in the image decoding method, a block shape of the current block may include a non-square shape.

In one embodiment, in the image decoding method, the producing of the filtered reference samples may include performing bi-linear filtering on the reference samples in a horizontal direction and a vertical direction when the filter is a strong filter, and performing smoothing filtering on the reference samples in the horizontal direction and the vertical direction when the filter is a weak filter.

In one embodiment, in the image decoding method, the determining of the filter may include determining the filter to be a strong filter when the width and height of the current block are each greater than or equal to a certain value.

In one embodiment, in the image decoding method, the determining of the filter may include determining the filter to be a strong filter when the sum of the width and height of the current block is greater than or equal to a certain value.

In one embodiment, in the image decoding method, the determining of the filter may include determining the filter to be a strong filter when a larger value among the width and height of the current block is greater than or equal to a certain value.

In one embodiment, in the image decoding method, the determining of the filter may include determining the filter to be a strong filter when a smaller value among the width and height of the current block is greater than or equal to a certain value.

In one embodiment, in the image decoding method, the certain value may be determined by a size of a largest coding unit.

In one embodiment, in the image decoding method, the certain value may be determined by a maximum size of a transform unit.

In one embodiment, the image decoding method may further include determining whether filtering is to be performed, based on the intra-prediction mode and the width and height of the current block.

According to another aspect of the present disclosure, an image decoding device includes a receiver configured to receive an encoded bitstream; and a decoder configured to obtain information regarding an intra-prediction mode of a current block from the bitstream, determine a filter based on a signal component of the current block, a width and height of the current block, and a value of at least one among reference samples neighboring the current block, produce filtered reference samples by applying the filter to the reference samples, and produce a predicted sample of the current block, based on the filtered reference samples and the intra-prediction mode.

In one embodiment, in the image decoding device, a block shape of the current block may include a non-square shape.

In one embodiment, in the image decoding device, the decoder may determine the filter to be a strong filter when the width and height of the current block are each greater than or equal to a certain value.

In one embodiment, in the image decoding device, the decoder may determine the filter to be a strong filter when the sum of the width and height of the current block is greater than or equal to a certain value.

According to another aspect of the present disclosure, an image encoding method includes determining an intra-prediction mode of a current block; determining a filter, based on a signal component of the current block, a width and height of the current block, and a value of at least one of reference samples neighboring the current block; producing filtered reference samples by applying the filter to the reference samples; producing a predicted sample of the current block, based on the filtered reference samples and the intra-prediction mode; and encoding information regarding the intra-prediction mode.

According to another aspect of the present disclosure, there is provided a non-transitory computer-readable recording medium having recorded thereon a program for executing the above method in a computer.

### ADVANTAGEOUS EFFECTS OF DISCLOSURE

Reference samples may be filtered even for any geometric block such as a square block or a non-square block.

### BRIEF DESCRIPTION OF DRAWINGS

FIG. 1 is a block diagram illustrating a structure of an image encoding device 100 according to an embodiment.

FIG. 2 is a detailed block diagram of an image encoding device 200 according to an embodiment.

FIG. 3 is a block diagram illustrating a structure of an image decoding device 300 according to an embodiment.

FIG. 4 is a detailed block diagram of an image decoding device 400 according to an embodiment.

FIG. 5 is a diagram illustrating reference samples used for intra-prediction according to an embodiment.

FIG. 6 is a diagram illustrating reference samples used for intra-prediction according to another embodiment.

FIG. 7 illustrates various intra-prediction modes.

FIG. 8 is a flowchart of an image encoding method according to an embodiment.

FIG. 9 is a flowchart of an image decoding method according to an embodiment.

FIG. 10 illustrates processes of determining at least one coding unit as a current coding unit is split, according to an embodiment.

FIG. 11 illustrates processes of determining at least one coding unit when a coding unit having a non-square shape is split, according to an embodiment.

FIG. 12 illustrates processes of splitting a coding unit, based on at least one of a block shape information and split type information, according to an embodiment.

FIG. 13 illustrates a method of determining a predetermined coding unit from among an odd number of coding units, according to an embodiment.

FIG. 14 illustrates an order of processing a plurality of coding units when the plurality of coding units are determined when a current coding unit is split, according to an embodiment.

FIG. 15 illustrates processes of determining that a current coding unit is split into an odd number of coding units when coding units are not processable in a predetermined order, according to an embodiment.

FIG. 16 illustrates processes of determining at least one coding unit when a first coding unit is split, according to an embodiment.

FIG. 17 illustrates that a shape into which a second coding unit is splittable is restricted when the second coding unit having a non-square shape determined when a first coding unit is split satisfies a predetermined condition, according to an embodiment.

FIG. 18 illustrates processes of splitting a coding unit having a square shape when split type information is unable to indicate that a coding unit is split into four square shapes, according to an embodiment.

FIG. 19 illustrates that an order of processing a plurality of coding units may be changed according to processes of splitting a coding unit, according to an embodiment.

FIG. 20 illustrates processes of determining a depth of a coding unit as a shape and size of the coding unit are changed, when a plurality of coding units are determined when the coding unit is recursively split, according to an embodiment.

FIG. 21 illustrates a part index (PID) for distinguishing depths and coding units, which may be determined according to shapes and sizes of coding units, according to an embodiment.

FIG. 22 illustrates that a plurality of coding units are determined according to a plurality of predetermined data units included in a picture, according to an embodiment.

FIG. 23 illustrates a processing block serving as a criterion of determining a determination order of reference coding units included in a picture, according to an embodiment.

### MODE OF DISCLOSURE

Advantages and features of embodiments set forth herein and methods of achieving them will be apparent from the following description of the embodiments in conjunction with the accompanying drawings. However, the present disclosure is not limited to these embodiments and may be embodied in many different forms. The embodiments are merely provided so that this disclosure will be thorough and complete and will fully convey the scope of the present disclosure to those of ordinary skill in the art.

The terms used herein will be briefly described and then embodiments set forth herein will be described in detail.

In the present disclosure, general terms that have been widely used nowadays are selected, if possible, in consideration of functions of the present disclosure, but non-general terms may be selected according to the intentions of technicians in the art, precedents, or new technologies, etc. Some terms may be arbitrarily chosen by the present applicant. In this case, the meanings of these terms will be explained in corresponding parts of the present disclosure in detail. Thus, the terms used herein should be defined not based on the names thereof but based on the meanings thereof and the whole context of the present disclosure.

As used herein, the singular forms “a”, “an” and “the” are intended to include the plural forms as well, unless the context clearly indicates otherwise.

It will be understood that when an element is referred to as including another element, the element may further include other elements unless mentioned otherwise. The term “unit” used herein should be understood as software or a hardware component, such as a FPGA or an ASIC, which performs certain functions. However, the term “unit” is not limited to software or hardware. The term “unit” may be configured to be stored in an addressable storage medium or to reproduce one or more processors. Thus, for example, the term “unit” may include components, such as software components, object-oriented software components, class components, and task components, processes, functions, attributes, procedures, subroutines, segments of program code, drivers, firmware, microcode, a circuit, data, database, data structures, tables, arrays, and parameters. Functions provided in components and “units” may be combined to obtain a small number of components and “units” or may be divided into sub-components and “sub-units”.

Hereinafter, the term “image” should be understood to include a static image, such as a still image of a video, and a moving picture, i.e., a dynamic image, which is a video.

Embodiments will be described in detail with reference to the accompanying drawings below such that those of ordinary skill in the art may easily implement them. In the drawings, for clarity, parts that are not related to describing the present disclosure are omitted.

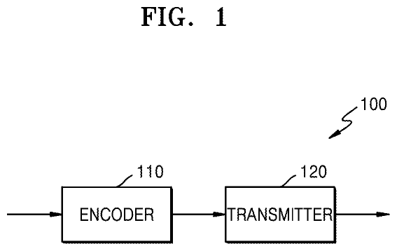

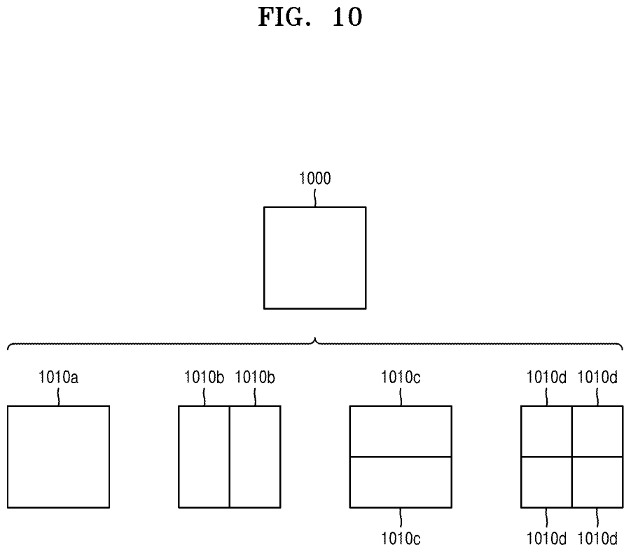

An image encoding device, an image decoding device, an image encoding method, and an image decoding method according to embodiments will be described in detail with reference to FIGS. 1 to 23 below. A method of filtering reference samples according to an embodiment will be described with reference to FIGS. 1 to 9 below, and a method of determining a data unit of an image will be described with reference to FIGS. 10 to 23 below.

FIG. 1 is a schematic block diagram of a structure of an image encoding device 100 according to an embodiment.

The image encoding device 100 according to an embodiment includes an encoder 110 and a transmitter 120.

In one embodiment, the encoder 110 may split image data of a current picture into largest coding units according to a maximum size of a coding unit. Each of the largest coding units may include coding units split based on split information. In one embodiment, image data of a spatial domain of each of the largest coding units may be hierarchically classified based on the split information. A block shape of each coding unit may be a square shape or a non-square shape, or may be any geometric shape and thus is not limited to a data unit of a certain size.

When the size of a picture to be encoded is increased and a larger unit is used for image encoding, an image may be encoded at a higher image compression ratio. However, when large coding units are used and the size thereof is fixed, an image may not be efficiently encoded by reflecting variable image characteristics.

For example, when a flat image, e.g., a sea or sky image, is encoded, a compression ratio may be increased by increasing the size of coding units. When a complicated image, e.g., a people or building image, is encoded, a compression ratio may be increased by reducing the size of coding units.

To this end, in one embodiment, the encoder 110 sets a largest coding unit of a different size for each picture or slice and sets split information of one or more coding units to be split from the largest coding unit. Sizes of the one or more coding units to be included in the largest coding unit may be variably set based on the split information.

The split information of the one or more coding units may be determined based on calculation of a rate-distortion (R-D) cost. The split information may be differently determined for each picture or slice or may be differently determined for each largest coding unit.

In one embodiment, split information of a coding unit split from a largest coding unit may be characterized by a block shape and a split shape. A method of determining a coding unit according to a block shape and a split shape will be described in detail with reference to FIGS. 10 to 23 below.

According to an embodiment, the coding units included in the largest coding unit may be predicted or transformed (for example, values in the pixel domain may be transformed into values in the frequency domain) based on different-sized processing units. In other words, the image encoding apparatus 100 may perform a plurality of processing operations for image encoding, based on various-sized and various-shaped processing units. Processing operations such as prediction, transformation, and entropy encoding are performed to encode image data, and equal-sized processing units or different-sized processing units may be used for the operations.

According to an embodiment, a prediction mode of a coding unit may include at least one of an intra mode, an inter mode, and a skip mode, and a certain prediction mode may be performed on only a certain-sized or -shaped coding unit. According to an embodiment, a prediction mode having the smallest coding error may be selected by performing prediction on each coding unit.

The image encoding device 100 may perform prediction encoding based on coding units that are not split any longer. Hereinafter, coding units, which are not split any longer and on which prediction encoding is based, will be referred to as ‘prediction unit’.

The image encoding apparatus 100 may transform image data based on a processing unit having a size different from that of a coding unit. The coding unit may be transformed based on a data unit having a size smaller than or equal to that of the coding unit. Hereinafter, the processing unit serving as a basis of transformation is called a ‘transform unit’.

Not only the split information but also prediction-related information and transformation-related information are needed as information to be used for encoding. Accordingly, the encoder 110 may determine split information causing a minimum encoding error, a prediction mode of each coding unit, a size of a transform unit for transformation, etc.

According to an embodiment, the encoder 110 may measure a coding error of the coding unit by using rate-distortion optimization (R-D optimization) based on a Lagrangian multiplier).

According to an embodiment, the transmitter 120 outputs image data of coding unit encoded based on at least one coding unit determined by the encoder 110, and information about a coding mode per coding unit, in the form of a bitstream and transmits the bitstream to a decoding apparatus.

The encoded image data may be a result of encoding residual data of an image.

The information regarding the encoding mode of each coding unit may include the split information, information regarding the block shape, information regarding the split shape, information regarding the prediction mode of each coding unit, information regarding the size of the transform unit, etc.

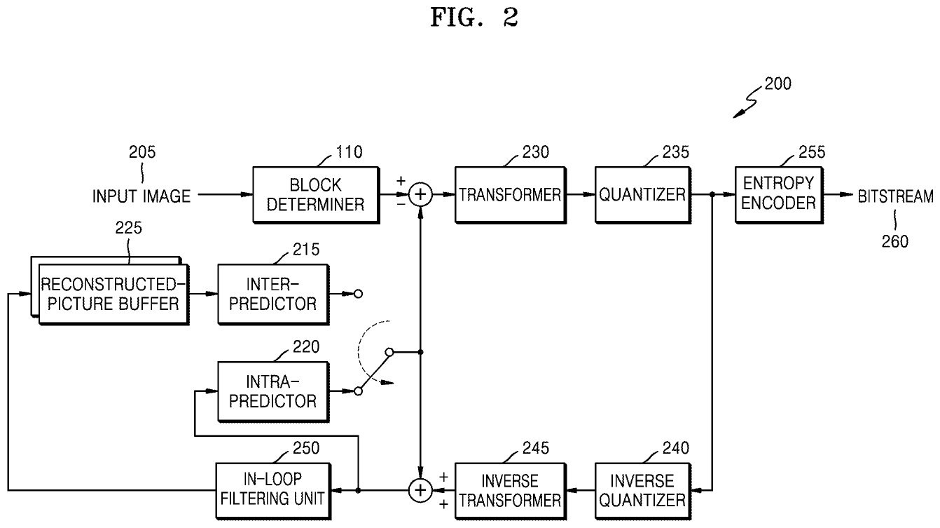

FIG. 2 is a detailed block diagram of an image encoding device 200 according to an embodiment.

The image encoding device 200 of FIG. 2 may correspond to the image encoding device 100 of FIG. 1.

In one embodiment, the image encoding device 200 may include a block determiner 210, an inter-predictor 215, an intra-predictor 220, a reconstructed-picture buffer 225, a transformer 230, a quantizer 235, an inverse quantizer 240, an inverse transformer 245, an in-loop filtering unit 250, and an entropy encoder 255.

The components illustrated in FIG. 2 are merely illustrated as independent components to describe different functions of the image encoding device 200 and thus should not be understood as being separated hardware components or components of software. That is, the components are illustrated as individual components for convenience of explanation, and at least two of them may be combined into one or one of them may be divided into a plurality of components to perform functions. An embodiment in which some of the components are combined into one and an embodiment in which one of the components is divided into a plurality of components are also included in the scope of the present disclosure unless the embodiments depart from the essence of the present disclosure.

In one embodiment, the block determiner 210 may split a picture constituting an input image 205 into at least one processing unit. In this case, the at least one processing unit may be a prediction unit (PU), a transform unit (TU), or a coding unit (CU). The block determiner 210 may encode a picture by splitting the picture into combinations of a coding unit, a prediction unit, and a transform unit and thereafter selecting a combination of a coding unit, a prediction unit, and a transform unit according to a certain criterion (e.g., a cost function).

For example, one picture may be split into a plurality of coding units. In order to split a picture into coding units, a recursive structure such as a tree structure may be used. Coding units split from a largest coding unit as a root may be each split into the number of child nodes corresponding to that of the coding units. A coding unit that is not split any longer according to a certain restriction serves as a leaf node. In this case, each of the coding units may have a square shape or a non-square shape or may have any geometric shape.

Hereinafter, the term “coding unit’ may be understood to mean a unit for performing encoding or a unit for performing decoding.

In one embodiment, the image encoding device 200 may determine whether inter-prediction or an intra-prediction is to be performed on a prediction unit and determine concrete information (e.g., an intra-prediction mode, a motion vector, a reference picture, etc.) for each prediction method. In this case, a processing unit, on which prediction is performed, a prediction method, and a processing unit of which details are determined may be the same or different. For example, a prediction method and a prediction mode may be determined in units of prediction units, and prediction may be performed in units of transform units. Alternatively, a prediction method and a prediction mode may be determined and prediction may be performed in units of processing blocks. The processing blocks will be described with reference to FIGS. 10 to 23 below.

In one embodiment, a residual value (a residual block) between a predicted block and an original block may be input to the transformer 230. Furthermore, prediction mode information, motion vector information, etc. used for prediction may be encoded by the entropy encoder 255, together with the residual value, and the encoded information may be transmitted to a decoding device. When a specific encoding mode is used, the predicted block may not be produced, and the original block may be directly encoded and information thereof may be transmitted to the decoding device.

In one embodiment, the inter-predictor 215 may predict a prediction unit, based on information regarding at least one of a previous picture or a subsequent picture of a current picture. In some cases, the inter-predictor 215 may predict a prediction unit, based on information regarding some encoded regions of the current picture.

The inter-predictor 215 may include a reference picture interpolator, a motion predictor, and a motion compensator. The reference picture interpolator may receive information regarding a reference picture from the reconstructed-picture buffer 225, and produce information regarding pixels having sizes equal to or less than that of an integer pixel from the reference picture. In the case of a luminance pixel, a DCT-based 8-tap interpolation filter may be used to produce information regarding pixels having sizes equal to or less than that of an integer pixel in units of ¼ pixels by using a different filter coefficient. In the case of a chrominance signal, a DCT-based 4-tap interpolation filter may be used to produce information regarding pixels having sizes equal to or less than that of an integer pixel in units of ⅛ pixels by using a different filter coefficient. The motion predictor may perform motion prediction, based on reference pictures interpolated by the reference picture interpolator. Various methods, such as a full search-based block matching algorithm (FBMA), a three-step search (TSS), and a new three-step search algorithm (NTS), may be used to calculate a motion vector. The motion vector may have a motion vector value of a ½ or ¼ pixel unit, based on interpolated pixels. The motion predictor may predict a current prediction unit by changing a motion prediction method. Various methods, such as a skip method, a merge method, an advanced motion vector prediction (AMVP) method, and an intra block copy method, may be used as the motion prediction method.

In one embodiment, the intra-predictor 220 may produce a prediction unit, based on information regarding a reference pixel neighboring a current block which is information regarding a pixel included in a current picture. When a neighboring block of a current prediction unit is an inter-predicted block and thus a reference pixel is an inter-predicted pixel, the reference pixel included in the inter-predicted block may be replaced with information of a reference pixel of a neighboring intra-predicted block. That is, when the reference pixel is not available, information of the unavailable reference pixel may be replaced with at least one of available reference pixels.

In intra-prediction, prediction modes may include directional prediction modes in which reference pixel information is used according to a prediction direction and a non-directional mode in which directional information is not used for prediction. The number of directional prediction modes may be equal to or greater than 33 as defined in the HEVC standard. A mode for predicting luminance information and a mode for predicting chrominance information may be different from each other, and either intra-prediction mode information used for predicting the luminance information or predicted luminance signal information may be used to predict the chrominance information.

In an intra-prediction method, a predicted block may be produced after applying a smoothing filter to a reference sample according to a prediction mode. Different filters may be applied to reference samples. Various types of filters may be applied to reference samples. For example, a strong filter may perform bi-linear filtering on reference samples in horizontal and vertical directions. For example, a weak filter may perform smoothing filtering on reference samples in the horizontal and vertical directions. For example, smoothing filtering may include filtering performed by applying a [1,2,1]/4 filter in the horizontal and vertical directions.

In order to perform the intra-prediction method, an intra-prediction mode of a current prediction unit may be predicted from that of a neighboring prediction unit of the current prediction unit. In case that a prediction mode of the current prediction unit is predicted using mode information predicted from the neighboring prediction unit, information indicating that the intra-prediction mode of the current prediction unit and an intra-prediction mode of the neighboring prediction unit are the same may be transmitted using certain flag information when the intra-prediction modes of the current prediction unit and the neighboring prediction unit are the same, and prediction mode information of a current block may be encoded by performing entropy encoding when the intra-prediction modes of the current prediction unit and the neighboring prediction unit are different.

In one embodiment, a residual block including residual information, which is a difference value between a prediction unit produced by the inter-predictor 215 or the intra-predictor 220, and an original block may be produced. The produced residual block may be input to the transformer 230.

In one embodiment, the transformer 230 may transform the residual block by a transformation method such as discrete cosine transform (DCT), discrete sine transform (DST), or Karhunen-Loeve transform (KLT).

In one embodiment, the quantizer 235 may quantize values transformed into a frequency domain by the transformer 230. Quantized transform coefficients may vary according to a block or the importance of an image. The quantized transform coefficients produced by the quantizer 235 are reconstructed as spatial-domain residual data through the inverse quantizer 240 and the inverse transformer 245. The reconstructed spatial-domain residual data is added to predicted data of each block output from the intra-predictor 220 or the inter-predictor 215 so as to reconstruct spatial-domain data of a block of the input image 205. A reconstructed image is produced from the reconstructed spatial-domain data through the in-loop filtering unit 250. The in-loop filtering unit 250 may perform deblocking only or may sequentially perform deblocking and sample adaptive offset (SAO) filtering. The generated reconstructed image is stored in the reconstructed-picture buffer 225. Reconstructed pictures stored in the reconstructed-picture buffer 225 may be used as reference pictures for inter-prediction of other pictures. The quantized transform coefficients obtained by the transformer 230 and the quantizer 235 may pass through the entropy encoder 255 and then be output as a bitstream 260.

The bitstream 260 output from the image encoding device 200 may include a result of encoding the residual data. The bitstream 260 may further include a result of encoding information indicating a block shape, a split shape, a size of a transform unit, etc.

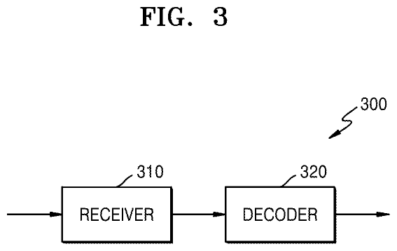

FIG. 3 is a schematic block diagram of a structure of an image decoding device 300 according to an embodiment.

Referring to FIG. 3, the image decoding device 300 according to an embodiment includes a receiver 310 and a decoder 320.

In one embodiment, the receiver 310 receives an encoded bitstream from the image encoding device 100.

In one embodiment, the decoder 320 parses the received bitstream to obtain image data in units of coding units. The decoder 320 may extract information regarding a current picture or slice from a parameter set raw byte sequence payload (RBSP) of the current picture or slice.

In one embodiment, the decoder 320 parses a bit string received by the image decoding device 300 to extract information regarding a size of a largest coding unit, split information of coding units split from the largest coding unit, and an encoding mode of the coding units. The information regarding the encoding mode may include information regarding a block shape, information regarding a split shape, prediction mode information of each of the coding units, size information regarding a transform unit, etc.

In one embodiment, the decoder 320 reconstructs a current picture by decoding image data of each of determined coding units, based on the determined coding units.

The decoder 320 may decode the coding units included in the largest coding unit, based on the split information of the coding units split from the largest coding unit. A process of decoding the coding units may include inverse quantization, inverse transformation, intra-prediction, and a motion prediction process including motion compensation.

In one embodiment, the decoder 320 may produce residual data by performing inverse quantization and inverse transformation on each of the coding units, based on information regarding a transform unit for the coding units. The decoder 320 may perform intra-prediction or inter-prediction, based on information regarding a prediction mode of the coding units. The decoder 320 may perform prediction on a prediction unit on which prediction is based and thereafter produce reconstructed data using predicted data of the coding units and the residual data.

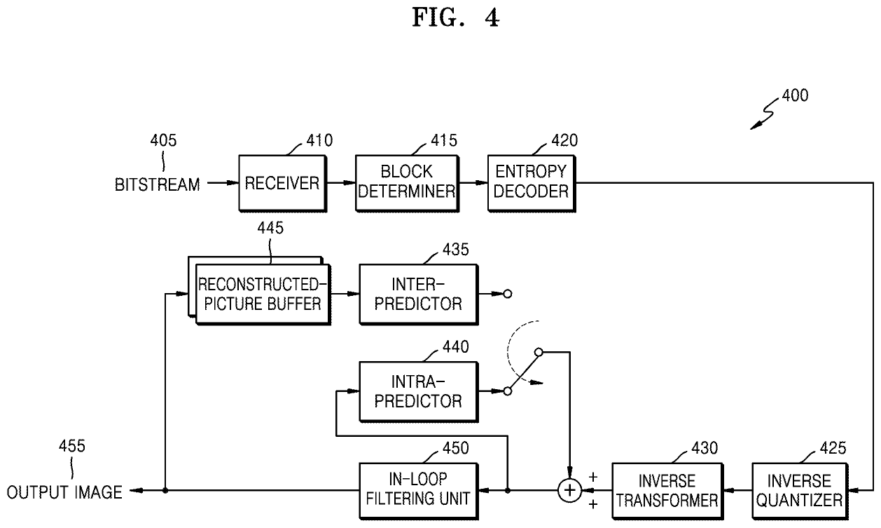

FIG. 4 is a detailed block diagram of an image decoding device 400 according to an embodiment.

The image decoding device 400 of FIG. 4 may correspond to the image decoding device 300 of FIG. 3.

In one embodiment, the image decoding device 400 performs operations to decode an image. In one embodiment, the image decoding device 400 may include a receiver 410, a block determiner 415, an entropy decoder 420, an inverse quantizer 425, an inverse transformer 430, an inter-predictor 435, an intra-predictor 440, a reconstructed-picture buffer 445, and an in-loop filtering unit 450.

In one embodiment, the receiver 410 receives a bitstream 405 of an encoded image.

In one embodiment, the block determiner 415 may split image data of a current picture into largest coding units, based on a maximum block size for splitting the image. Each of the largest coding units may include blocks (i.e., coding units) split therefrom according to a block shape and a split shape. In one embodiment, the block determiner 415 may obtain split information from the bitstream 405 and hierarchically split spatial-domain image data according to the block shape and the split shape. When the blocks to be used for decoding have a certain shape and size, the block determiner 415 may split the image data without using the split information.

In one embodiment, the entropy decoder 420 may perform entropy decoding in an order opposite that in which entropy encoding is performed by the entropy encoder 255 of the image encoding device 200. For example, various methods, such as exponential-Golomb coding, context-adaptive variable length coding (CAVLC), and context-adaptive binary arithmetic coding (CABAC), corresponding to a method performed by the image encoding device 200 may be applied.

The entropy decoder 420 may decode encoded image data and information related to intra-prediction and inter-prediction performed by the image encoding device 200. The encoded image data is a quantized transform coefficient, and the inverse quantizer 425 and the inverse transformer 430 reconstruct residual data from the quantized transform coefficient.

In one embodiment, the inverse quantizer 425 may perform inverse quantization, based on a quantization parameter and rearranged block coefficient values provided from the image encoding device 200.

In one embodiment, the inverse transformer 430 may perform inverse transformation, i.e., inverse DCT, inverse DST, or inverse KLT, on a result of performing transformation, i.e., DCT, DST, or KLT, on a result of quantization, which is performed by the image encoding device 200, by the transformer 230. The inverse transformation may be performed based on a transmission unit determined by the image encoding device 200. The inverse transformer 430 may selectively perform a prediction method and a transformation method (e.g., DCT, DST, or KLT) according to a plurality of pieces of information such as a size of a current block and a prediction direction.

The inter-predictor 435 or the intra-predictor 440 may produce a predicted block, based on information related to production of a predicted block, which is provided from the entropy decoder 420, and a previously decoded block or picture provided from the reconstructed-picture buffer 445.

As described above, a processing unit on which prediction is performed and a processing unit for determining a prediction method and details may be the same or be different. For example, the prediction method, a prediction mode, etc. may be determined using a prediction unit and prediction may be performed using a transform unit. Alternatively, the prediction method and the prediction mode may be determined and prediction may be performed in units of processing blocks. The processing blocks will be described with reference to FIGS. 10 to 23 below.

In one embodiment, the inter-predictor 435 may perform inter-prediction on a current prediction unit by using information necessary for inter-prediction of the current prediction unit and provided from the image encoding device 200, based on information included in at least one of a previous picture or a subsequent picture of a current picture including the current prediction unit. Alternatively, inter-prediction may be performed based on information of already reconstructed some regions of the current picture including the current prediction unit. For inter-prediction, the image decoding device 400 may determine whether a motion prediction method for a prediction unit included in a coding unit is a skip mode, a merge mode, an AMVP mode, or an inter block copy mode, based on the coding unit.

In one embodiment, the intra-predictor 440 may produce a predicted block based on information regarding samples included in the current picture. When a prediction unit is an intra-predicted prediction unit, intra-prediction may be performed based on intra-prediction mode information of the prediction unit provided from the image encoding device 200. The intra-predictor 440 may include a reference-sample smoothing filter, a reference-sample interpolator, and a DC filter. The reference-sample smoothing filter is used to filter reference samples around a current block, and may be applied by determining whether to apply this filter according to a prediction mode of a current prediction unit. The reference samples of the current block may be filtered using a prediction mode of the prediction unit provided from the image encoding device 200 and filter information. Various types of filters may be applied to the reference samples. For example, a strong filter may perform bi-linear filtering on the reference samples in horizontal and vertical directions. For example, a weak filter may perform smoothing filtering on the reference samples in the horizontal and vertical directions. When a prediction mode of the current block is a mode in which filtering is not performed, the reference-sample smoothing filter may not be applied.

In one embodiment, when a prediction mode of a prediction unit is a prediction unit in which intra-prediction is performed based on a sample value obtained by interpolating reference samples, the reference sample interpolator may produce a reference sample which is a sample unit having a value equal to or less than an integer value by interpolating reference samples. When a prediction mode of the current prediction unit is a prediction mode in which a predicted block is produced without interpolating reference samples, the reference samples may not be interpolated. The DC filter may produce a predicted block by filtering when a prediction mode of a current block is a DC mode.

A reproduced block or picture may be provided to the in-loop filtering unit 450. The in-loop filtering unit 450 may include a deblocking filter, an offset corrector, and an ALF.

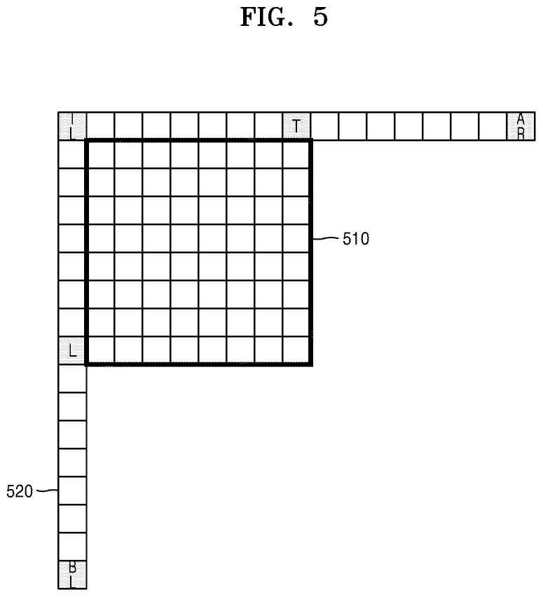

FIG. 5 is a diagram illustrating reference samples used for intra-prediction according to an embodiment.

As described above, the intra-predictors 220 and 440 perform prediction using neighboring reproduced (reconstructed) samples. In this case, neighboring reproduced samples of a current block, which are used for prediction, will be referred to as ‘reference samples’. In embodiments which will be described below, points, which are minimum units constituting an image, will be referred to as pixel elements, pixels, samples, or the like.

Referring to FIG. 5, a current block 510 has a square shape. When a size of the current block 510 is nT×nT, a total number of reference samples 520 needed is (4 nT+1), including 2 nT reference samples 520 at an upper side of the current block 510, 2 nT reference samples 520 at a left side thereof, and one reference sample 520 at an upper left side thereof. When there are no reference samples 520, the intra-predictors 220 and 440 may prepare reference samples 520 by performing padding on portions of the current block 510 having no reference samples 520. For example, when the current block 510 is located at a boundary of a picture, there are no reference samples 520 at the boundary. In this case, a closest sample among available samples neighboring the current block 510 may be filled for a non-existence sample by the intra-predictors 220 and 440.

The reference samples 520 used for intra-prediction are samples reconstructed by quantization and thus contain a quantization error. In order to reduce a prediction error caused by the quantization error, the intra-predictors 220 and 440 may apply the reference-sample smoothing filter to the reference samples 520.

In one embodiment, a filter applied to the reference samples 520 may be classified as a strong filter or a weak filter. Although the filter applied to the reference samples 520 will be described as the strong filter or the weak filter for convenience of explanation, filter strength may be defined more finely. The filter strength may be determined by performing a certain operation by an image decoding device or may be determined based on a flag or index identifying filter strength and signaled from an image encoding device.

For convenience of explanation, in the current embodiment, a pixel value of a reference sample to which the strong filter or the weak filter is applied will be indicated by ‘pF’ and a pixel value of a reference sample to which this filter has yet to be applied will be indicated by ‘p’. Thus, it should be understood that p[x][y] indicates a pixel value of a reference sample located at a position (x, y), and pF[x][y] indicates a pixel value of the reference sample located at the position (x, y) and to which the strong filter or the weak filter is applied. Here, x is an index representing the horizontal direction and y is an index representing the vertical direction.

Whether the strong filter or the weak filter is to be applied to the reference samples 520 may be determined considering the size of the current block 510, a result of comparing a value obtained by adding an offset to or subtracting the offset from an integer multiple of a value of the reference sample 520 at a reference position with the sum of values of two or more reference samples, etc. That is, whether the strong filter is to be applied to the reference samples 520 may be determined, based on a comparison between an amount of change between the reference samples 520 and a predetermined constant.

For example, Equations 1 and 2 below show examples of a condition of applying the strong filter.

Abs(p[−1][−1]+p[2H−1][−1]−2×p[H−1][−1])<threshold [Equation 1]

Abs(p[−1][−1]+p[2W−1][−1]−2×p[W−1][−1])<threshold [Equation 2]

In Equations 1 and 2 above, H and W respectively represent a height and width of the current block 510. For example, when the current block 510 has a size of 32×32, H and W may each be 32.

Referring to FIG. 5, p[−1][−1] indicates a sample value at a position ‘TL’ on an upper left side of the current block 510, p[2H−1][−1] indicates a sample value of a position ‘BL’, p[H−1][−1] indicates a sample value at a position ‘L’, p[2W−1][−1] indicates a sample value at a position ‘AR’, and p[W−1][−1] indicates a sample value at a position ‘T’.

In Equations 1 and 2 above, the threshold may be a value determined by a bit depth. The bit depth is a value representing a depth of the current block 510 and may indicate, for example, the number of times of splitting from a largest coding unit to the current block 510.

The strong filter may be applied to the reference samples 520 when Equations 1 and 2 above are satisfied, and the weak filter may be applied to the reference samples 520 when at least one of Equation 1 or 2 above is not satisfied.

In one embodiment, the intra-predictors 220 and 440 may apply the strong filter to the reference samples 520, when a signal component of the current block 510 is a luma component, Equations 1 and 2 above are satisfied, and the size of the current block 510 satisfies a certain condition. In this case, the certain condition of the size of the current block 510 may be variously set.

In one embodiment, a condition of applying the strong filter may be satisfied when the width and height of the current block 510 are each greater than or equal to a certain value. In this case, the value may be determined by a size of the largest coding unit. Alternatively, the value may be determined by a maximum size of a transform unit. For example, the condition of applying the strong filter may be satisfied when the width and height of the current block 510 are each greater than or equal to 32.

In one embodiment, the condition of applying the strong filter may be satisfied when the sum of the width and height of the current block 510 is greater than or equal to a certain value. In this case, the value may be determined by the size of the largest coding unit. Alternatively, the value may be determined by the maximum size of the transform unit. For example, the condition of applying the strong filter may be satisfied when the sum of the width and height of the current block 510 is greater than or equal to 64.

Equation 3 below is provided to explain an example of deriving filtered reference samples pF by applying the strong filter to the reference samples 520.

pF[−1][−1]=p[−1][−1]

pF[−1][y]=((2H−1−y)*p[−1][−1]+(y+1)*p[−1][2H−1]+H)»6

pF[−1][2H−1]=p[−1][2H−1]

pF[x][−1]=((2W−1−x)*p[−1][−1]+(x+1)*p[2W−1][−1]+W)»6

pF[2W−1][−1]=p[2W−1][−1] [Equation 3]

In Equation 3 above, x may be a value ranging from 0 to (2W−2) and y may be a value ranging from 0 to (2H−2).

Equation 4 below is provided to explain an example of deriving filtered reference samples pF by applying the weak filter to the reference samples 520.

pF[−1][−1]=(p[−1][0]+2*p[−1][−1]+p[0][−1]+2)»2

pF[−1][y]=(p[−1][y+1]+2*p−1][y]+p[−1][y−1]+2)»2

pF[−1][2H−1]=p[−1][2H−1]

pF[x][−1]=(p[x−1][−1]+2*p[x][−1]+p[x+1][−1]+2)»2

pF[2W−1][−1]=p[2W−1][−1] [Equation 4]

In Equation 4 above, x may be a value ranging from 0 to (2W−2) and y may be a value ranging from 0 to (2H−2).

In one embodiment, the intra-predictors 220 and 440 may produce a predicted sample of the current block 510, based on filtered reference samples obtained by applying the strong filter according to Equation 3 or the weak filter according to Equation 4, and a determined intra-prediction mode.

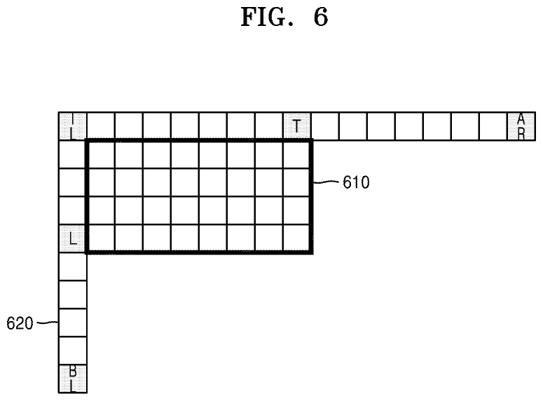

FIG. 6 is a diagram illustrating reference samples used for intra-prediction according to another embodiment.

Referring to FIG. 6, a current block 610 has a non-square shape. When a size of the current block 610 is nW×nH, a total number of reference samples 620 needed is (2 nW+2 nH+1), including 2 nW reference samples 620 at an upper side of the current block 610, 2 nH reference samples 620 at a left side thereof, and one reference sample 620 at an upper left side thereof. When there are no reference samples 620, the intra-predictors 220 and 440 may prepare reference samples 620 by performing padding on portions of the current block 610 having no reference samples 620.

As described above with reference to FIG. 5, a filter applied to the current block 610 of the non-square shape may be classified as a strong filter or a weak filter.

Whether the strong filter or the weak filter is to be applied to the reference samples 620 may be determined considering the size of the current block 610, a result of comparing a value obtained by adding an offset to or subtracting the offset from an integer multiple of a value of the reference sample 620 at a reference position with the sum of values of two or more reference samples, etc. That is, whether the strong filter is to be applied to the reference samples 620 may be determined, based on a comparison between an amount of change between the reference samples 620 and a predetermined constant.

Similarly, in one embodiment, a condition of applying the strong filter to the reference samples 620 of the current block 610 of the non-square shape may include Equations 1 and 2 above. However, a width and height of the current block 610 are different due to the non-square shape of the current block 610 and thus a certain condition regarding a width and height may be given.

For example, the intra-predictors 220 and 440 may apply the strong filter to the reference samples 620, when a signal component of the current block 610 is a luma component, Equations 1 and 2 are satisfied, and the width and height of the current block 610 satisfy the condition regarding a width and height.

In one embodiment, the width and height of the current block 610 may be each greater than or equal to a certain value Tsize, so that the strong filter may be applied to the reference samples 620. For example, the strong filter may be applied to the reference samples 620 when the width and height of the current block 610 are each greater than or equal to 32. The value Tsize may be set to 4, 8, 16, 32, 64, 128 or the like or may be set to various values other than a value expressed by 2ⁿ (here, n is an integer).

In one embodiment, the sum of the width and height of the current block 610 may be greater than or equal to a certain value Tsum, so that the strong filter may be applied to the reference samples 620. For example, the strong filter may be applied to the reference samples 620 when the sum of the width and height of the current block 610 is greater than or equal to 32. The value Tsum may be set to 4, 8, 16, 32, 64, 128 or the like or may be set to various values other than a value expressed by 2ⁿ (here, n is an integer).

In one embodiment, a larger value among the width and height of the current block 610 may be greater than or equal to a certain value Tmax, so that the strong filter may be applied to the reference samples 620. For example, the strong filter may be applied to the reference samples 620 when the larger value among the width and height of the current block 610 is greater than or equal to 32. The value Tmax may be set to 4, 8, 16, 32, 64, 128 or the like or may be set to various values other than a value expressed by 2ⁿ (here, n is an integer).

In one embodiment, a smaller value among the width and height of the current block 610 may be greater than or equal to a certain value Tmin, so that the strong filter may be applied to the reference samples 620. For example, the strong filter may be applied to the reference samples 620 when the smaller value among the width and height of the current block 610 is greater than or equal to 32. The value Tmin may be set to 4, 8, 16, 32, 64, 128 or the like or may be set to various values other than a value expressed by 2ⁿ (here, n is an integer).

In one embodiment, the values Tsize, Tsum, Tmax, and Tmin may be values determined by the size of the largest coding unit. Alternatively, the values Tsize, Tsum, Tmax, and Tmin may be values determined by the maximum size of the transform unit.

In one embodiment, the intra-predictors 220 and 440 may produce a predicted sample of the current block 610, based on filtered reference samples obtained by applying the strong filter according to Equation 3 or the weak filter according to Equation 4, and a determined intra-prediction mode. When Equations 1 to 4 are applied to the current block 610 of the non-square shape, H and W respectively represent the height and width of the current block 610.

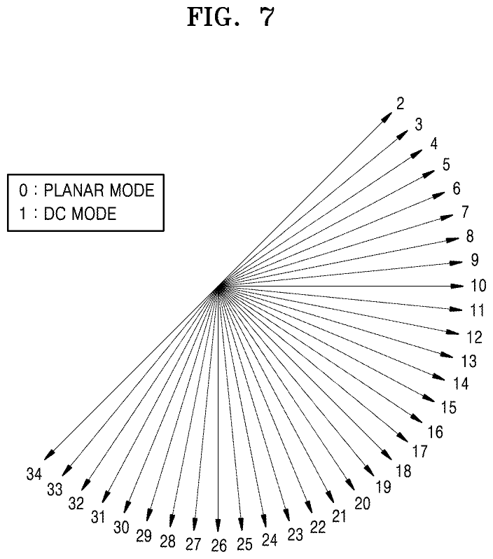

FIG. 7 illustrates various intra-prediction modes.

Although embodiments set forth herein are explained based on 35 intra-prediction modes defined in HEVC for convenience of explanation, more than 35 intra-prediction modes (i.e., expanded intra-prediction modes) are also applicable to these embodiments.

Intra-prediction modes may be largely divided into non-directional modes (a planar mode and the DC mode) and a directional mode (an angular mode). As illustrated in FIG. 5, in the directional mode, directivity varies according to a mode.

Whether a filter is to be applied to reference samples may be determined based on information (e.g., a 1-bit flag) signaled from an image encoding device but may be determined based on at least one of a width of a current block, a height of the current block, or an intra-prediction mode.

For example, when a current block has a size of 4×4, the filter may be applied only when an intra-prediction mode of the current block is ‘18’. When the current block has a size of 32×32, the filter may be applied when the intra-prediction mode of the current block is the directional mode other than ‘10’. However, the above examples are merely provided to explain examples, and whether the filter is to be applied may be determined by various combinations of the width of the current block, the height of the current block, and the intra-prediction mode.

For example, when the weight and height of the current block are each equal to or less than a reference value (e.g., 4), the filter may not be applied to the reference samples regardless of the intra-prediction mode of the current block. For example, when the sum of the weight and height of the current block is equal to or less than a reference value (e.g., 8), the filter may not be applied to the reference samples regardless of the intra-prediction mode of the current block. As another example, when a larger value among the width and height of the current block is equal to or less than a reference value, the filter may not be applied to the reference samples regardless of the intra-prediction mode of the current block. As another example, when a smaller value among the width and height of the current block is equal to or less than a reference value, the filter may not be applied to the reference samples regardless of the intra-prediction mode of the current block.

For example, when the width and height of the current block are each greater than or equal to a reference value (e.g., 32), the filter may be applied to the reference samples regardless of the intra-prediction mode of the current block. For example, when the sum of the width and height of the current block is greater than or equal to a reference value (e.g., 64), the filter may be applied to the reference samples regardless of the intra-prediction mode of the current block. As another example, when the larger value of the width and height of the current block is greater than or equal to a reference value, the filter may be applied to the reference samples regardless of the intra-prediction mode of the current block. As another example, when the smaller value among the width and height of the current block is greater than or equal to a reference value, the filter may be applied to the reference samples regardless of the intra-prediction mode of the current block.

When the intra-prediction mode of the current block is a non-directional mode, whether the filter is to be applied may be determined according to the width and height of the current block. For example, the filter may be applied to the reference samples when the intra-prediction mode of the current block is the non-directional mode and the width and height of the current block are greater than or equal to a reference value.

As another example, when the intra-prediction mode of the current block is the non-directional mode, the filter may be applied to the reference samples regardless of the width and height of the current block. As another example, when the intra-prediction mode of the current block is the non-directional mode, the filter may not be applied to the reference samples regardless of the width and height of the current block.

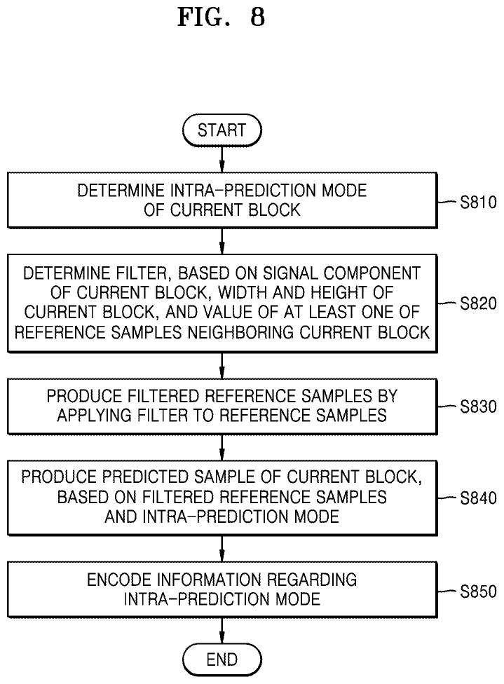

FIG. 8 is a flowchart of an image encoding method according to an embodiment.

In operation S810, the encoder 110 of the image encoding device 100 may determine an intra-prediction mode of a current block.

In operation S820, the encoder 110 may determine a filter, based on a signal component of the current block, a width and height of the current block, and a value of at least one of reference samples neighboring the current block. For example, the encoder 110 may apply a strong filter to the reference samples, when the signal component of the current block is a luma component, a result of comparing a value obtained by adding an offset to or subtracting the offset from an integer multiple of a value of a reference sample at a reference position with the sum of values of two or more reference samples is less than a certain threshold, and the width and height of the current block satisfies a certain condition.

In operation S830, the encoder 110 may produce filtered reference samples by applying the filter to the reference samples.

In operation S840, the encoder 110 may produce a predicted sample of the current block, based on the filtered reference samples and the intra-prediction mode.

In operation S850, the encoder 110 may encode information regarding the intra-prediction mode. The encoded information regarding the intra-prediction mode may be output as a bitstream, together with encoded image data, and the bitstream may be transmitted to the image decoding device 300 via the transmitter 120.

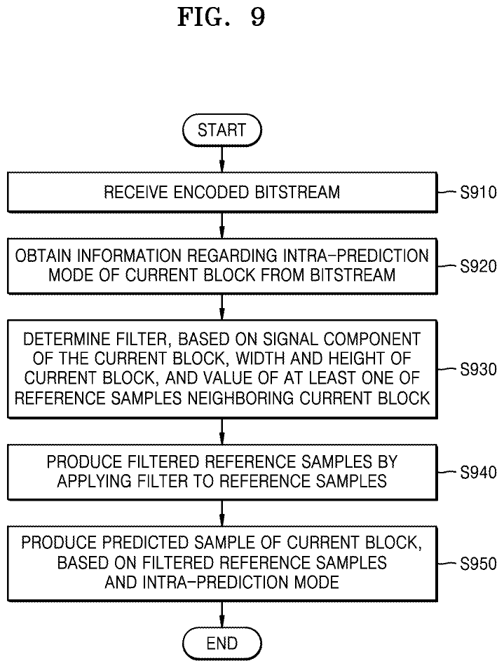

FIG. 9 is a flowchart of an image decoding method according to an embodiment.

In operation S910, the receiver 310 of the image decoding device 300 may receive an encoded bitstream.

In operation S920, the decoder 320 of the image decoding device 300 may obtain information regarding an intra-prediction mode of a current block from the bitstream.

In operation S930, the decoder 320 may determine a filter, based on a signal component of the current block, a width and height of the current block, and a value of at least one of reference samples neighboring the current block. For example, the decoder 320 may apply a strong filter to the reference samples, when the signal component of the current block is a luma component, a result of comparing a value obtained by adding an offset to or subtracting the offset from an integer multiple of a value of a reference sample at a reference position with the sum of values of two or more reference samples is less than a certain threshold, and the width and height of the current block satisfies a certain condition.

In operation S940, the decoder 320 may produce filtered reference samples by applying the filter to the reference samples.

In operation S950, the decoder 320 may produce a predicted sample of the current block, based on the filtered reference samples and the intra-prediction mode.

A method of determining a data unit of an image, according to an embodiment will now be described in detail with reference to FIGS. 10 to 23.

FIG. 10 is a diagram showing a procedure, performed by the image decoding apparatus 300, of determining at least one coding unit by splitting a current coding unit 1000, according to an embodiment.

According to an embodiment, the image decoding apparatus 300 may determine a shape of a coding unit by using block shape information, and determine a shape into which a coding unit is split by using split type information. In other words, a split method of a coding unit, which is indicated by the split type information, may be determined based on a block shape indicated by the block shape information used by the image decoding apparatus 300.

According to an embodiment, the image decoding apparatus 300 may use block shape information indicating that a current coding unit has a square shape. For example, the image decoding apparatus 300 may determine, according to split type information, whether to not split a square coding unit, to split the square coding unit vertically, to split the square coding unit horizontally, or to split the square coding unit into four coding units. Referring to FIG. 10, when block shape information of a current coding unit 1000 indicates a square shape, the decoder 320 may not split a coding unit 1010a having the same size as the current coding unit 1000 according to split type information indicating non-split, or determine coding units 1010b, 1010c, or 1010d based on split type information indicating a certain split method.

Referring to FIG. 10, the image decoding apparatus 300 may determine two coding units 1010b by splitting the current coding unit 1000 in a vertical direction based on split type information indicating a split in a vertical direction, according to an embodiment. The image decoding apparatus 300 may determine two coding units 1010c by splitting the current coding unit 1000 in a horizontal direction based on split type information indicating a split in a horizontal direction. The image decoding apparatus 300 may determine four coding units 1010d by splitting the current coding unit 1000 in vertical and horizontal directions based on split type information indicating splitting in vertical and horizontal directions. However, a split shape into which a square coding unit may be split is not limited to the above shapes, and may include any shape indicatable by split type information. Certain split shapes into which a square coding unit are split will now be described in detail through various embodiments.

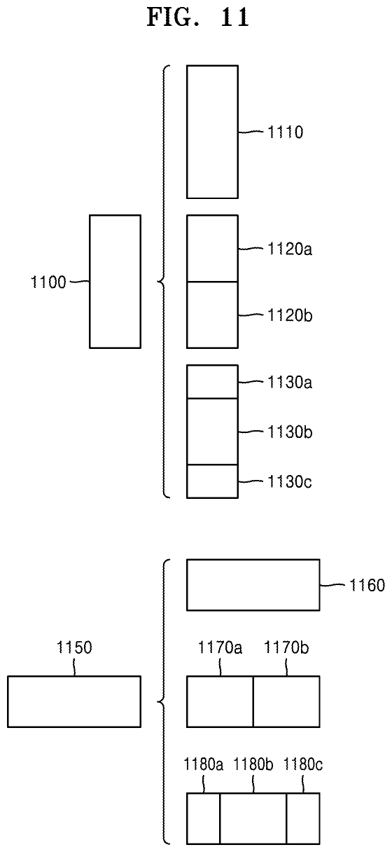

FIG. 11 illustrates processes of determining at least one coding unit when the image decoding apparatus 300 splits a coding unit having a non-square shape, according to an embodiment.

According to an embodiment, the image decoding apparatus 300 may use block shape information indicating that a current coding unit has a non-square shape. The image decoding apparatus 300 may determine, according to split type information, whether to not split the non-square current coding unit or to split the non-square current coding unit via a certain method. Referring to FIG. 11, when block shape information of a current coding unit 1100 or 1150 indicates a non-square shape, the image decoding apparatus 300 may not split coding units 1110 or 1160 having the same size as the current coding unit 1100 or 1150 according to split type information indicating non-split, or determine coding units 1120a, 1120b, 1130a, 1130b, 1130c, 1170a, 1170b, 1180a, 1180b, and 1180c based on split type information indicating a certain split method. A certain split method of splitting a non-square coding unit will now be described in detail through various embodiments.

According to an embodiment, the image decoding apparatus 300 may determine a shape into which a coding unit is split by using split type information, and in this case, the split type information may indicate the number of at least one coding unit generated as the coding unit is split. Referring to FIG. 11, when split type information indicates that the current coding unit 1100 or 1150 is split into two coding units, the image decoding apparatus 300 may determine two coding units 1120a and 1120b or 1170a and 1170b included in the current coding unit 1100 or 1150 by splitting the current coding unit 1100 or 1150 based on the split type information.

According to an embodiment, when the image decoding apparatus 300 splits the current coding unit 1100 or 1150 having a non-square shape based on split type information, the image decoding apparatus 200 may split the current coding unit 1100 or 1150 considering locations of long sides of the current coding unit 1100 or 1150 having a non-square shape. For example, the image decoding apparatus 300 may determine a plurality of coding units by splitting the current coding unit 1100 or 1150 in a direction of splitting the long sides of the current coding unit 1100 or 1150 considering a shape of the current coding unit 1100 or 1150.

According to an embodiment, when split type information indicates that a coding unit is split into an odd number of blocks, the image decoding apparatus 300 may determine the odd number of coding units included in the current coding unit 1100 or 1150. For example, when split type information indicates that the current coding unit 1100 or 1150 is split into three coding units, the image decoding apparatus 300 may split the current coding unit 1100 or 1150 into three coding units 1130a through 1130c or 1180a through 1180c. According to an embodiment, the image decoding apparatus 300 may determine the odd number of coding units included in the current coding unit 1100 or 1150, and the sizes of the determined coding units may not be all the same. For example, the size of coding unit 1130b or 1180b from among the determined odd number of coding units 1130a through 1130c or 1180a through 1180c may be different from the sizes of coding units 1130a and 1130c or 1180a and 1180c. In other words, coding units that may be determined when the current coding unit 1100 or 1150 is split may have a plurality of types of sizes.

According to an embodiment, when split type information indicates that a coding unit is split into an odd number of blocks, the image decoding apparatus 300 may determine the odd number of coding units included in the current coding unit 1100 or 1150, and in addition, may set a certain limit on at least one coding unit from among the odd number of coding units generated via splitting. Referring to FIG. 11, the image decoding apparatus 300 may differentiate decoding processes performed on the coding unit 1130b or 1180b located at the center from among the three coding units 1130a through 1130c or 1180a through 1180c generated as the current coding unit 1100 or 1150 is split from the other coding units 1130a and 1130c or 1180a and 1180c. For example, the image decoding apparatus 300 may limit the coding unit 1130b or 1180b located at the center to be no longer split unlike the other coding units 1130a and 1130c or 1180a and 1180c, or to be split only a certain number of times.

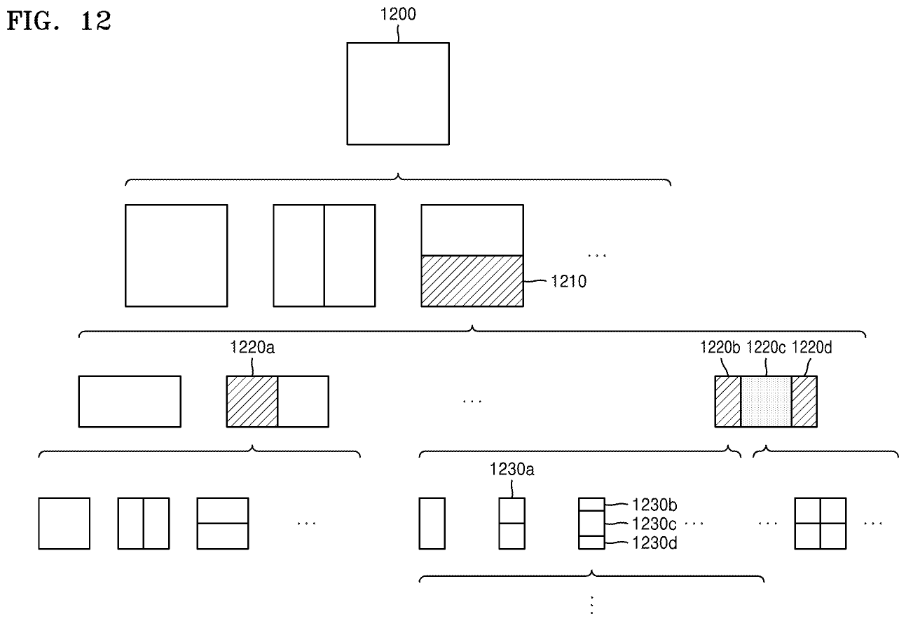

FIG. 12 illustrates processes of the image decoding apparatus 300 splitting a coding unit, based on at least one of a block shape information and split type information, according to an embodiment.

According to an embodiment, the image decoding apparatus 300 may determine that a first coding unit 1200 having a square shape is split or not split into coding units, based on at least one of block shape information and split type information. According to an embodiment, when split type information indicates that the first coding unit 1200 is split in a horizontal direction, the image decoding apparatus 300 may determine a second coding unit 1210 by splitting the first coding unit 1200 in a horizontal direction. A first coding unit, a second coding unit, and a third coding unit used according to an embodiment are terms used to indicate a relation between before and after splitting a coding unit. For example, a second coding unit may be determined by splitting a first coding unit, and a third coding unit may be determined by splitting a second coding unit. Hereinafter, it will be understood that relations between first through third coding units are in accordance with the features described above.

According to an embodiment, the image decoding apparatus 300 may determine that the determined second coding unit 1210 is split or not split into coding units based on at least one of block shape information and split type information. Referring to FIG. 12, the image decoding apparatus 300 may split the second coding unit 1210, which has a non-square shape and is determined by splitting the first coding unit 1200, into at least one third coding unit 1210a, 1220b, 1220c, or 1220d, or may not split the second coding unit 1210, based on at least one of block shape information and split type information. The image decoding apparatus 300 may obtain at least one of the block shape information and the split type information, and obtain a plurality of second coding units (for example, the second coding units 1210) having various shapes by splitting the first coding unit 1200 based on at least one of the obtained block shape information and split type information, wherein the second coding unit 1210 may be split according to a method of splitting the first coding unit 1200 based on at least one of the block shape information and the split type information. According to an embodiment, when the first coding unit 1200 is split into the second coding units 1210 based on at least one of block shape information and split type information with respect to the first coding unit 1200, the second coding unit 1210 may also be split into third coding units (for example, the third coding units 1220a through 1220d) based on at least one of block shape information and split type information with respect to the second coding unit 1210. In other words, a coding unit may be recursively split based on at least one of split type information and block shape information related to each coding unit. Methods which may be used to recursively split a coding unit will be described with respect to various embodiments below.

According to an embodiment, the image decoding apparatus 300 may determine that each of the third coding units 1220a through 1220d is split into coding units or that the second coding unit 1210 is not split, based on at least one of block shape information and split type information. The image decoding apparatus 300 may split the second coding unit 1210 having a non-square shape into the odd number of third coding units 1220b through 1220d, according to an embodiment. The image decoding apparatus 300 may set a certain limit on a certain third coding unit from among the third coding units 1220b through 1220d. For example, the image decoding apparatus 300 may limit that the third coding unit 1220c located at the center of the third coding units 1220b through 1220d is no longer split, or is split into a settable number of times. Referring to FIG. 12, the image decoding apparatus 300 may limit that the third coding unit 1220c located at the center of the third coding units 1220b through 1220d included in the second coding unit 1210 having a non-square shape is no longer split, is split into a certain split shape (for example, split into four coding units or split into shapes corresponding to those into which the second coding unit 1210 is split), or is split only a certain number of times (for example, split only n times wherein n>0). However, such limits on the third coding unit 1220c located at the center are only examples and should not be interpreted as being limited by those examples, but should be interpreted as including various limits as long as the third coding unit 1220c located at the center are decoded differently from the other third coding units 1220b and 1220d.

According to an embodiment, the image decoding apparatus 300 may obtain at least one of block shape information and split type information used to split a current coding unit from a certain location in the current coding unit.

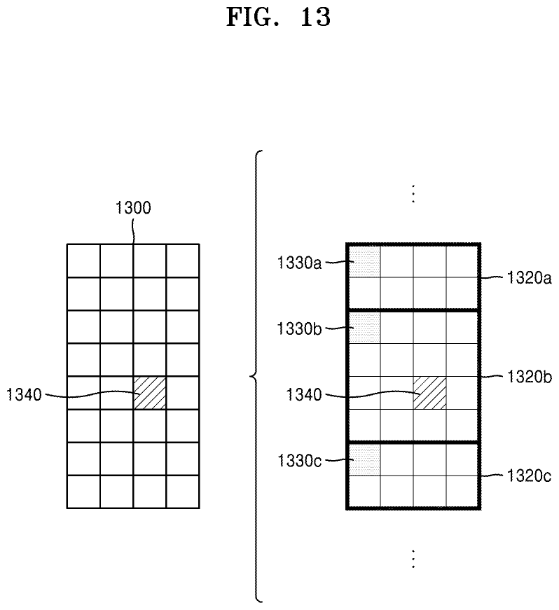

FIG. 13 illustrates a method of determining, by the image decoding apparatus 300, a certain coding unit from among an odd number of coding units, according to an embodiment. Referring to FIG. 13, at least one of block shape information and split type information of a current coding unit 1300 may be obtained from a sample at a certain location (for example, a sample 1340 located at the center) from among a plurality of samples included in the current coding unit 1300. However, the certain location in the current coding unit 1300 from which at least one of block shape information and split type information is obtained is not limited to the center location shown in FIG. 13, but may be any location (for example, an uppermost location, a lowermost location, a left location, a right location, an upper left location, a lower left location, an upper right location, or a lower right location) included in the current coding unit 1300. The image decoding apparatus 300 may determine that a current coding unit is split into coding units having various shapes and sizes or is not split by obtaining at least one of block shape information and split type information from a certain location.

According to an embodiment, the image decoding apparatus 300 may select one coding unit when a current coding unit is split into a certain number of coding units. A method of selecting one of a plurality of coding units may vary, and details thereof will be described below through various embodiments.

According to an embodiment, the image decoding apparatus 300 may split a current coding unit into a plurality of coding units, and determine a coding unit at a certain location.

FIG. 13 illustrates a method of determining, by the image decoding apparatus 300, a coding unit at a certain location from among an odd number of coding units, according to an embodiment.

According to an embodiment, the image decoding apparatus 300 may use information indicating a location of each of the odd number of coding units so as to determine a coding unit located at the center from among the odd number of coding units. Referring to FIG. 13, the image decoding apparatus 300 may determine the odd number of coding units 1320a through 1320c by splitting the current coding unit 1300. The image decoding apparatus 300 may determine the center coding unit 1320b by using information about the locations of the odd number of coding units 1320a through 1320c. For example, the image decoding apparatus 300 may determine the coding unit 1320b located at the center by determining the locations of the coding units 1320a through 1320b based on information indicating locations of certain samples included in the coding units 1320a through 1320c. In detail, the image decoding apparatus 300 may determine the coding unit 1320b located at the center by determining the locations of the coding units 1320a through 1320c based on information indicating locations of upper left samples 1330a through 1330c of the coding units 1320a through 1320c.

According to an embodiment, the information indicating the locations of the upper left samples 1330a through 1330c included in the coding units 1320a through 1320c respectively may include information about a location or coordinates of the coding units 1320a through 1320c in a picture. According to an embodiment, the information indicating the locations of the upper left samples 1330a through 1330c included in the coding units 1320a through 1320c respectively may include information indicating widths or heights of the coding units 1320a through 1320c included in the current coding unit 1300, and such widths or heights may correspond to information indicating differences between coordinates of the coding units 1320a through 1320c in a picture. In other words, the image decoding apparatus 300 may determine the coding unit 1320b located at the center by directly using the information about the locations or coordinates of the coding units 1320a through 1320c in a picture or by using information about the widths or heights of the coding units 1320a through 1320c corresponding to the differences between coordinates.

According to an embodiment, the information indicating the location of the upper left sample 1330a of the upper coding unit 1320a may indicate (xa, ya) coordinates, the information indicating the location of the upper left sample 1330b of the center coding unit 1320b may indicate (xb, yb) coordinates, and the information indicating the location of the upper left sample 1330c of the lower coding unit 1320c may indicate (xc, yc) coordinates. The image decoding apparatus 300 may determine the center coding unit 1320b by using the coordinates of the upper left samples 1330a through 1330c respectively included in the coding units 1320a through 1320c. For example, when the coordinates of the upper left samples 1330a through 1330c are arranged in an ascending order or descending order, the coding unit 1320b including the coordinates (xb, yb) of the sample 1330b located at the center may be determined as a coding unit located at the center from among the coding units 1320a through 1320c determined when the current coding unit 1300 is split. However, coordinates indicating the locations of the upper left samples 1330a through 1330c may be coordinates indicating absolute locations in a picture, and in addition, (dxb, dyb) coordinates, i.e., information indicating a relative location of the upper left sample 1330b of the center coding unit 1320b, and (dxc, dyc) coordinates, i.e., information indicating a relative location of the upper left sample 1330c of the lower coding unit 1320c, may be used based on the location of the upper left sample 1330a of the upper coding unit 1320a. Also, a method of determining a coding unit at a certain location by using, as information indicating locations of samples included in coding units, coordinates of the samples is not limited to the above, and various arithmetic methods capable of using coordinates of samples may be used.

According to an embodiment, the image decoding apparatus 300 may split the current coding unit 1300 into the plurality of coding units 1320a through 1320c, and select a coding unit from the coding units 1320a through 1320c according to a certain standard. For example, the image decoding apparatus 300 may select the coding unit 1320b having a different size from among the coding units 1320a through 1320c.

According to an embodiment, the image decoding apparatus 300 may determine widths or heights of the coding units 1320a through 1320c by respectively using the (xa, ya) coordinates, i.e., the information indicating the location of the upper left sample 1330a of the upper coding unit 1320a, the (xb, yb) coordinates, i.e., the information indicating the location of the upper left sample 1330b of the center coding unit 1320b, and the (xc, yc) coordinates, i.e., the information indicating the location of the upper left sample 1330c of the lower coding unit 1320c. The image decoding apparatus 300 may determine the sizes of the coding units 1320a through 1320c by respectively using the coordinates (xa, ya), (xb, yb), and (xc, yc) indicating the locations of the coding units 1320a through 1320c.

According to an embodiment, the image decoding apparatus 300 may determine the width of the upper coding unit 1320a to be xb-xa, and the height to be yb-ya. According to an embodiment, the image decoding apparatus 300 may determine the width of the center coding unit 1320b to be xc-xb, and the height to be yc-yb. According to an embodiment, the image decoding apparatus 300 may determine the width or height of the lower coding unit 1320c by using the width and height of the current coding unit 1300 and the widths and heights of the upper coding unit 1320a and center coding unit 1320b. The image decoding apparatus 300 may determine a coding unit having a different size from other coding units based on the determined widths and heights of the coding units 1320a through 1320c. Referring to FIG. 13, the image decoding apparatus 300 may determine the center coding unit 1320b having a size different from those of the upper coding unit 1320a and lower coding unit 1320c as a coding unit at a certain location. However, processes of the image decoding apparatus 300 determining a coding unit having a different size from other coding units are only an example of determining a coding unit at a certain location by using sizes of coding units determined based on sample coordinates, and thus various processes of determining a coding unit at a certain location by comparing sizes of coding units determined according to certain sample coordinates may be used.

However, a location of a sample considered to determine a location of a coding unit is not limited to the upper left as described above, and information about a location of an arbitrary sample included in a coding unit may be used.

According to an embodiment, the image decoding apparatus 300 may select a coding unit at a certain location from among an odd number of coding units determined when a current coding unit is split, while considering a shape of the current coding unit. For example, when the current coding unit has a non-square shape in which a width is longer than a height, the image decoding apparatus 300 may determine a coding unit at a certain location in a horizontal direction. In other words, the image decoding apparatus 300 may determine one of coding units having a different location in the horizontal direction and set a limit on the one coding unit. When the current coding unit has a non-square shape in which a height is longer than a width, the image decoding apparatus 300 may determine a coding unit at a certain location in a vertical direction. In other words, the image decoding apparatus 200 may determine one of coding units having a different location in the vertical direction and set a limit on the one coding unit.

According to an embodiment, the image decoding apparatus 300 may use information indicating a location of each of an even number of coding units so as to determine a coding unit at a certain location from among the even number of coding units. The image decoding apparatus 300 may determine the even number of coding units by splitting a current coding unit, and determine the coding unit at the certain location by using information about the locations of the even number of coding units. Detailed processes thereof may correspond to those of determining a coding unit at a certain location (for example, a center location) from among an odd number of coding units described in FIG. 13, and thus details thereof are not provided again.

According to an embodiment, when a current coding unit having a non-square shape is split into a plurality of coding units, certain information about a coding unit at a certain location during splitting processes may be used to determine the coding unit at the certain location from among the plurality of coding units. For example, the image decoding apparatus 300 may use at least one of block shape information and split type information stored in a sample included in a center coding unit during splitting processes so as to determine a coding unit located at the center from among a plurality of coding units obtained by splitting a current coding unit.

Referring to FIG. 13, the image decoding apparatus 300 may split the current coding unit 1300 into the plurality of coding units 1320a through 1320c based on at least one of block shape information and split type information, and determine the coding unit 1320b located at the center from among the plurality of coding units 1320a through 1320c. In addition, the image decoding apparatus 300 may determine the coding unit 1320b located at the center considering a location from which at least one of the block shape information and the split type information is obtained. In other words, at least one of the block shape information and the split type information of the current coding unit 1300 may be obtained from the sample 1340 located at the center of the current coding unit 1300, and when the current coding unit 1300 is split into the plurality of coding units 1320a through 1320c based on at least one of the block shape information and the split type information, the coding unit 1320b including the sample 1340 may be determined as a coding unit located at the center. However, information used to determine a coding unit located at the center is not limited to at least one of the block shape information and the split type information, and various types of information may be used while determining a coding unit located at the center.

According to an embodiment, certain information for identifying a coding unit at a certain location may be obtained from a certain sample included in a coding unit to be determined. Referring to FIG. 13, the image decoding apparatus 300 may use at least one of block shape information and split type information obtained from a sample at a certain location in the current coding unit 1300 (for example, a sample located at the center of the current coding unit 1300), so as to determine a coding unit at a certain location (for example, a coding unit located at the center from among a plurality of coding units) from among the plurality of coding units 1320a through 1320c determined when the current coding unit 1300 is split. In other words, the image decoding apparatus 300 may determine the sample at the certain location considering a block shape of the current coding unit 1300, and determine and set a certain limit on the coding unit 1320b including a sample from which certain information (for example, at least one of block shape information and split type information) is obtainable, from among the plurality of coding units 1320a through 1320c determined when the current coding unit 1300 is split. Referring to FIG. 13, according to an embodiment, the image decoding apparatus 300 may determine, as a sample from which certain information is obtainable, the sample 1340 located at the center of the current coding unit 1300, and set a certain limit on the coding unit 1320b including such a sample 1340 during decoding processes. However, a location of a sample from which certain information is obtainable is not limited to the above, and may be a sample at an arbitrary location included in the coding unit 1320b determined to set a limit.

According to an embodiment, a location of a sample from which certain information is obtainable may be determined according to a shape of the current coding unit 1300. According to an embodiment, block shape information may determine whether a shape of a current coding unit is square or non-square, and determine a location of a sample from which certain information is obtainable according to the shape. For example, the image decoding apparatus 300 may determine, as a sample from which certain information is obtainable, a sample located on a boundary of splitting at least one of a width and a height of a current coding unit into halves by using at least one of information about the width of the current coding unit and information about the height of the current coding unit. As another example, when block shape information related to a current coding unit indicates a non-square shape, the image decoding apparatus 300 may determine, as a sample from which certain information is obtainable, one of samples adjacent to a boundary of splitting long sides of the current coding unit into halves.

According to an embodiment, when a current coding unit is split into a plurality of coding units, the image decoding apparatus 300 may use at least one of block shape information and split type information so as to determine a coding unit at a certain location from among the plurality of coding units. According to an embodiment, the image decoding apparatus 300 may obtain at least one of block shape information and split type information from a sample at a certain location included in a coding unit, and may split a plurality of coding units generated as a current coding unit is split by using at least one of the split type information and the block shape information obtained from the sample at the certain location included in each of the plurality of coding units. In other words, a coding unit may be recursively split by using at least one of block shape information and split type information obtained from a sample at a certain location included in each coding unit. Since processes of recursively splitting a coding unit have been described above with reference to FIG. 12, details thereof are not provided again.

According to an embodiment, the image decoding apparatus 300 may determine at least one coding unit by splitting a current coding unit, and determine an order of decoding the at least one coding unit according to a certain block (for example, the current coding unit).

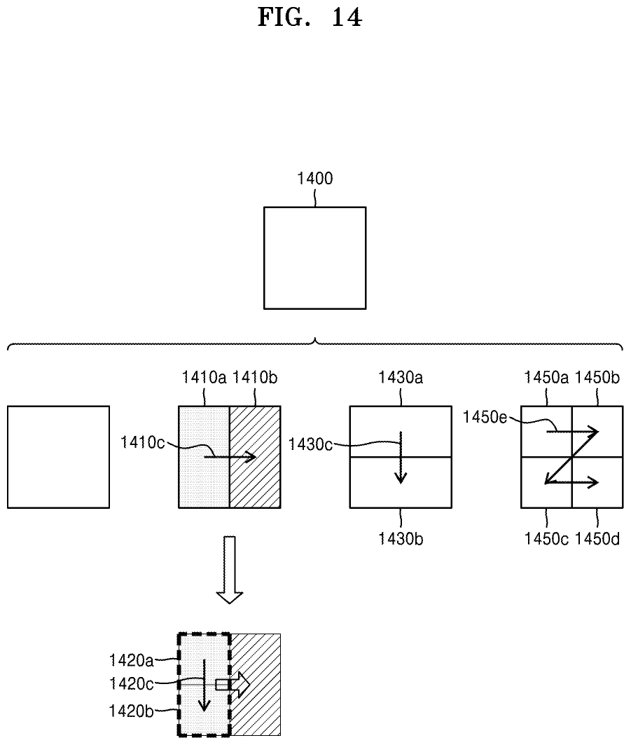

FIG. 14 illustrates an order of processing a plurality of coding units when the plurality of coding units are determined when the image decoding apparatus 300 splits a current coding unit, according to an embodiment.

According to an embodiment, the image decoding apparatus 300 may determine second coding units 1410a and 1410b by splitting a first coding unit 1400 in a vertical direction, determine second coding units 1430a and 1430b by splitting the first coding unit 1400 in a horizontal direction, or determine second coding units 1450a through 1450d by splitting the first coding unit 140 in horizontal and vertical directions, according to block shape information and split type information.

Referring to FIG. 14, the image decoding apparatus 300 may determine the second coding units 1410a and 1410b, which are determined by splitting the first coding unit 1400 in the vertical direction, to be processed in a horizontal direction 1410c. The image decoding apparatus 300 may determine the second coding units 1430a and 1430b, which are determined by splitting the first coding unit 1400 in the horizontal direction, to be processed in a vertical direction 1430c. The image decoding apparatus 300 may determine the second coding units 1450a through 1450d, which are determined by splitting the first coding unit 1400 in the vertical and horizontal directions, to be processed) according to a certain order in which coding units located in one row is processed and then coding units located in a next row is processed (for example, a raster scan order or a z-scan order 1450e).

According to an embodiment, the image decoding apparatus 300 may recursively split coding units. Referring to FIG. 14, the image decoding apparatus 300 may determine the plurality of second coding units 1410a and 1410b, 1430a and 1430b, or 1450a through 1450d by splitting the first coding unit 1400, and recursively split each of the plurality of second coding units 1410a and 1410b, 1430a and 1430b, or 1450a through 1450d. A method of splitting the plurality of second coding units 1410a and 1410b, 1430a and 1430b, or 1450a through 1450d may correspond to a method of splitting the first coding unit 1400. Accordingly, each of the plurality of second coding units 1410a and 1410b, 1430a and 1430b, or 1450a through 1450d may be independently split into a plurality of coding units. Referring to FIG. 14, the image decoding apparatus 300 may determine the second coding units 1410a and 1410b by splitting the first coding unit 1400 in the vertical direction, and in addition, determine that each of the second coding units 1410a and 1410b is independently split or not split.

According to an embodiment, the image decoding apparatus 300 may split the second coding unit 1410a at the left in a horizontal direction into third coding units 1420a and 1420b, and may not split the second coding unit 1410b at the right.

According to an embodiment, an order of processing coding units may be determined based on split processes of coding units. In other words, an order of processing coding units that are split may be determined based on an order of processing coding units before being split. The image decoding apparatus 300 may determine an order of processing the third coding units 1420a and 1420b determined when the second coding unit 1410a at the left is split independently from the second coding unit 1410b at the right. Since the third coding units 1420a and 1420b are determined when the second coding unit 1410a at the left is split in a horizontal direction, the third coding units 1420a and 1420b may be processed in a vertical direction 1420c. Also, since an order of processing the second coding unit 1410a at the left and the second coding unit 1410b at the right corresponds to the horizontal direction 1410c, the second coding unit 1410b at the right may be processed after the third coding units 1420a and 1420b included in the second coding unit 1410a at the left are processed in the vertical direction 1420c. The above descriptions are related processes of determining an order of processing coding units according to coding units before being split, but such processes are not limited to the above embodiments, and any method of independently processing, in a certain order, coding units split into various shapes may be used.

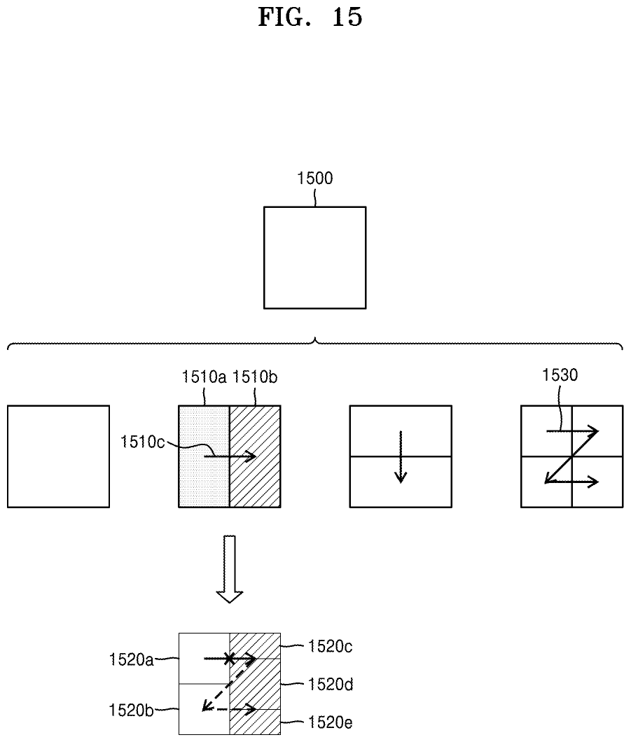

FIG. 15 illustrates processes of determining that a current coding unit is split into an odd number of coding units when coding units are not processable in a certain order by the image decoding apparatus 300, according to an embodiment.

According to an embodiment, the image decoding apparatus 300 may determine that a current coding unit is split into an odd number of coding units based on obtained block shape information and split type information. Referring to FIG. 15, a first coding unit 1500 having a square shape may be split into second coding units 1510a and 1510b having a non-square shape, and the second coding units 1510a and 1510b may be independently respectively split into third coding units 1520a and 1520b, and 1520c through 1520e. According to an embodiment, the image decoding apparatus 300 may split the second coding unit 1510a at the left from among the second coding units 1510a and 1510b into a horizontal direction to determine the plurality of third coding units 1520a and 1520b, and split the second coding unit 1510b at the right into the odd number of third coding units 1520c through 1520e.

According to an embodiment, the image decoding apparatus 300 may determine whether a coding unit split into an odd number exists by determining whether the third coding units 1520a through 1520e are processable in a certain order. Referring to FIG. 15, the image decoding apparatus 300 may determine the third coding units 1520a through 1520e by recursively splitting the first coding unit 1500. The image decoding apparatus 300 may determine, based on at least one of block shape information and split type information, whether a coding unit is split into an odd number from among shapes into which the first coding unit 1500, the second coding units 1510a and 1510b, or the third coding units 1520a through 1520e are split. For example, the second coding unit 1510b at the right from among the second coding units 1510a and 1510b may be split into the odd number of third coding units 1520c through 1520e. An order of processing a plurality of coding units included in the first coding unit 1500 may be a certain order (for example, a z-scan order 1530), and the image decoding apparatus 300 may determine whether the third coding units 1520c through 1520e determined when the second coding unit 1510b at the right is split into an odd number satisfy a condition of being processable according to the certain order.

According to an embodiment, the image decoding apparatus 300 may determine whether the third coding units 1520a through 1520e included in the first coding unit 1500 satisfy a condition of being processable according to a certain order, wherein the condition is related to whether at least one of a width and a height of each of the second coding units 1510a and 1510b is split into halves according to boundaries of the third coding units 1520a through 1520e. For example, the third coding units 1520a and 1520b determined when the height of the second coding unit 1510a at the left and having a non-square shape is split into halves satisfy the condition, but it may be determined that the third coding units 1520c through 1520e do not satisfy the condition because the boundaries of the third coding units 1520c through 1520e that are determined when the second coding unit 1510b at the right is split into three coding units do not split the width or height of the second coding unit 1510b at the right into halves. The image decoding apparatus 300 may determine disconnection of a scan order when the condition is not satisfied, and determine that the second coding unit 1510b at the right is split into the odd number of coding units, based on a result of the determination. According to an embodiment, the image decoding apparatus 300 may set a certain limit on a coding unit at a certain location from among an odd number of coding units obtained by splitting a coding unit, and since such a limit or certain location has been described above through various embodiments, details thereof are not provided again.

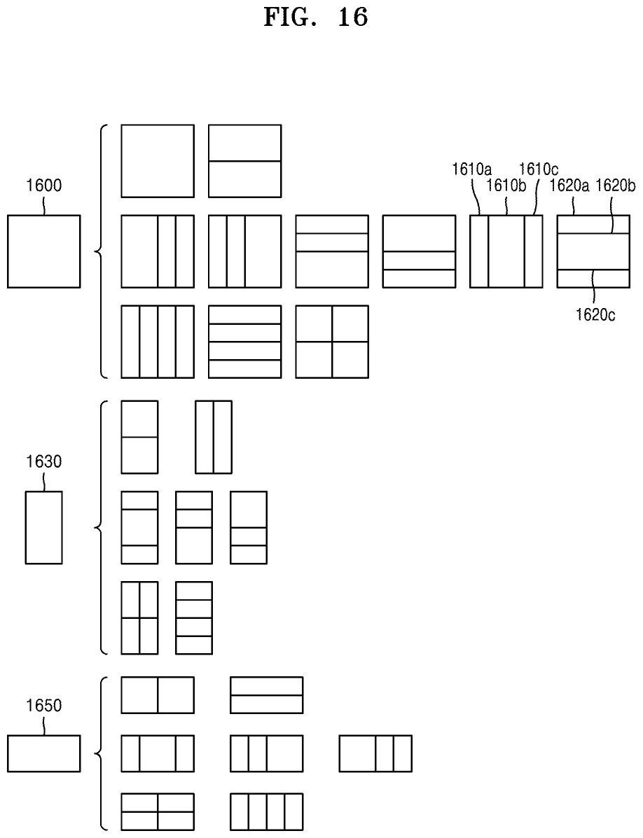

FIG. 16 illustrates processes of determining at least one coding unit when the image decoding apparatus 300 splits a first coding unit 1600, according to an embodiment. According to an embodiment, the image decoding apparatus 300 may split the first coding unit 1600 based on at least one of block shape information and split type information obtained through the receiver 210. The first coding unit 1600 having a square shape may be split into four coding units having a square shape or a plurality of coding units having a non-square shape. For example, referring to FIG. 16, when block shape information indicates that the first coding unit 1600 is a square and split type information indicates a split into non-square coding units, the image decoding apparatus 300 may split the first coding unit 1600 into a plurality of non-square coding units. In detail, when split type information indicates that an odd number of coding units are determined by splitting the first coding unit 1600 in a horizontal direction or a vertical direction, the image decoding apparatus 300 may determine, as the odd number of coding units, second coding units 1610a through 1610c by splitting the first coding unit 1600 having a square shape in a vertical direction, or second coding units 1620a through 1620c by splitting the first coding unit 1600 in a horizontal direction.

According to an embodiment, the image decoding apparatus 300 may determine whether the second coding units 1610a through 1610c and 1620a through 1620c included in the first coding unit 1600 satisfy a condition of being processable in a certain order, wherein the condition is related to whether at least one of a width and a height of the first coding unit 1600 is split into halves according to boundaries of the second coding units 1610a through 1610c and 1620a through 1620c. Referring to FIG. 16, since the boundaries of the second coding units 1610a through 1610c determined when the first coding unit 1600 having a square shape is split in a vertical direction do not split the width of the first coding unit 1600 into halves, it may be determined that the first coding unit 1600 does not satisfy the condition of being processable in a certain order. Also, since the boundaries of the second coding units 1620a through 1620c determined when the first coding unit 1600 having a square shape is split in a horizontal direction do not split the height of the first coding unit 1600 into halves, it may be determined that the first coding unit 1600 does not satisfy the condition of being processable in a certain order. The image decoding apparatus 300 may determine disconnection of a scan order when the condition is not satisfied, and determine that the first coding unit 1600 is split into the odd number of coding units based on a result of the determination. According to an embodiment, the image decoding apparatus 300 may set a certain limit on a coding unit at a certain location from among an odd number of coding units obtained by splitting a coding unit, and since such a limit or certain location has been described above through various embodiments, details thereof are not provided again.

According to an embodiment, the image decoding apparatus 300 may determine coding units having various shapes by splitting a first coding unit.

Referring to FIG. 16, the image decoding apparatus 300 may split the first coding unit 1600 having a square shape and a first coding unit 1630 or 1650 having a non-square shape into coding units having various shapes.

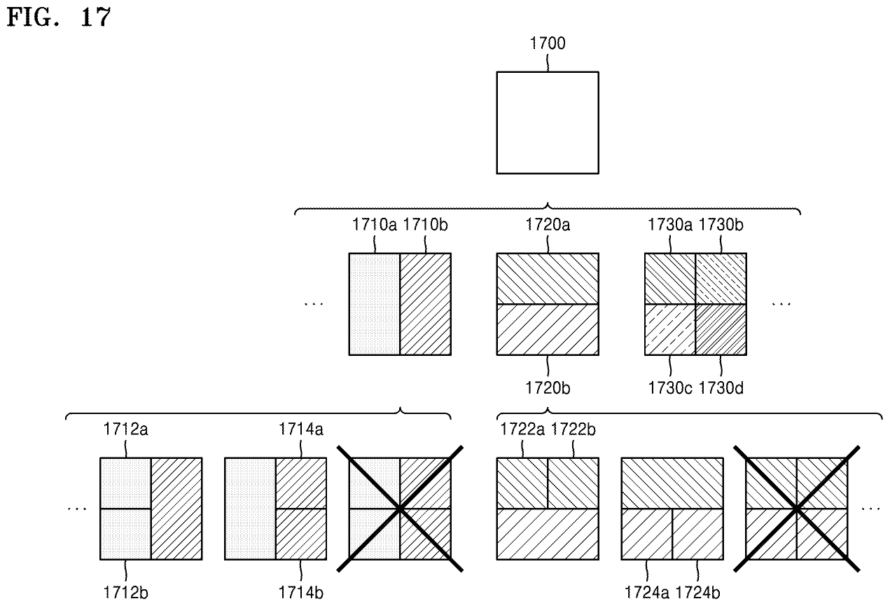

FIG. 17 illustrates that a shape into which a second coding unit is splittable by the image decoding apparatus 300 is restricted when the second coding unit having a non-square shape determined when a first coding unit 1700 is split satisfies a certain condition, according to an embodiment.

According to an embodiment, the image decoding apparatus 300 may determine that the first coding unit 1700 having a square shape is split into second coding units 1710a and 1710b or 1720a and 1720b having a non-square shape, based on at least one of block shape information and split type information obtained through the receiver 210. The second coding units 1710a and 1710b or 1720a and 1720b may be independently split. Accordingly, the image decoding apparatus 300 may determine that the second coding units 1710a and 1710b or 1720a and 1720b are split into a plurality of coding units or are not split based on at least one of block shape information and split type information related to each of the coding units 1710a and 1710b or 1720a and 1720b. According to an embodiment, the image decoding apparatus 300 may determine third coding units 1712a and 1712b by splitting, in a horizontal direction, the second coding unit 1710a at the left having a non-square shape, which is determined when the first coding unit 1700 is split in a vertical direction. However, when the second coding unit 1710a at the left is split in the horizontal direction, the image decoding apparatus 300 may set a limit that the second coding unit 1710b at the right is not split in the horizontal direction like the second coding unit 1710a at the left. When third coding units 1714a and 1714b are determined when the second coding unit 1710b at the right is split in the same direction, i.e., the horizontal direction, the third coding units 1712a, 1712b, 1714a, and 1714b are determined when the second coding units 1710a at the left and the second coding unit 1710b at the right are each independently split in the horizontal direction. However, this is the same result as splitting the first coding unit 1700 into four second coding units 1730a through 1730d having a square shape based on at least one of block shape information and split type information, and thus may be inefficient in terms of image decoding.

According to an embodiment, the image decoding apparatus 300 may determine third coding units 1722a and 1722b or 1724a, and 1724b by splitting, in a vertical direction, the second coding unit 1720a or 1720b having a non-square shape determined when the first coding unit 1700 is split in the horizontal direction. However, when one of second coding units (for example, the second coding unit 1720a at the top) is split in a vertical direction, the image decoding apparatus 300 may set a limit that the other second coding unit (for example, the second coding unit 1720b at the bottom) is not split in the vertical direction like the second coding unit 1720a at the top for the above described reasons.

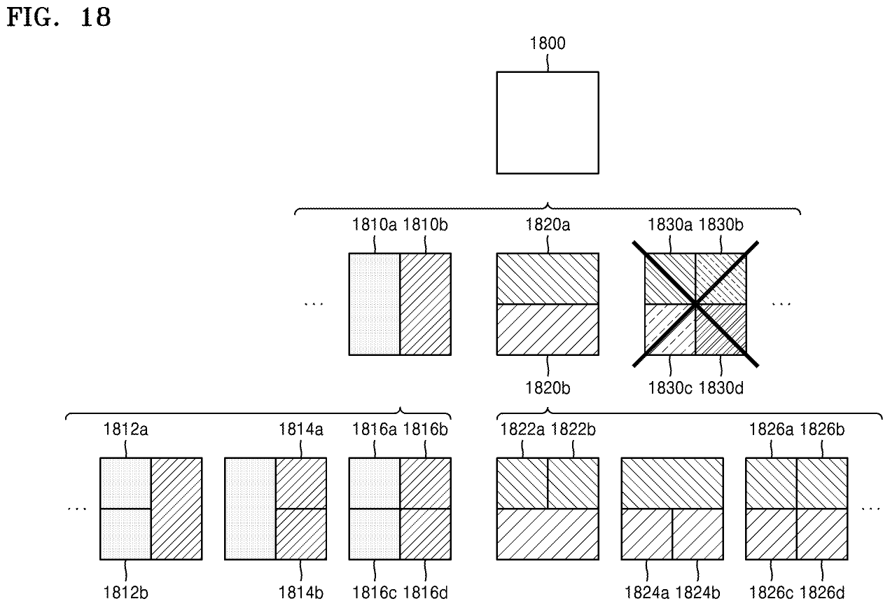

FIG. 18 illustrates processes of the image decoding apparatus 300 splitting a coding unit having a square shape when split type information is unable to indicate that a coding unit is split into four square shapes, according to an embodiment.

According to an embodiment, the image decoding apparatus 300 may determine second coding units 1810a and 1810b, or 1820a and 1820b, by splitting a first coding unit 1800 based on at least one of block shape information and split type information. Split type information may include information about various shapes into which a coding unit may be split, but such information about various shapes may not include information for splitting a coding unit into four square coding units. According to such split type information, the image decoding apparatus 300 is unable to split the first coding unit 1800 having a square shape into four second coding units 1830 through 1830d having a square shape. The image decoding apparatus 300 may determine the second coding units 1810a and 1810b, or 1820a and 1820b having a non-square shape based on the split type information.

According to an embodiment, the image decoding apparatus 300 may independently split each of the second coding units 1810a and 1810b, or 1820a and 1820b having a non-square shape. Each of the second coding units 1810a and 1810b, or 1820a and 1820b may be split in a certain order via a recursive method that may be a split method corresponding to a method of splitting the first coding unit 1800 based on at least one of the block shape information and the split type information.

For example, the image decoding apparatus 300 may determine third coding units 1812a and 1812b having a square shape by splitting the second coding unit 1810a at the left in a horizontal direction, or determine third coding units 1814a and 1814b having a square shape by splitting the second coding unit 1810b at the right in a horizontal direction. In addition, the image decoding apparatus 300 may determine third coding units 1816a through 1816d having a square shape by splitting both the second coding unit 1810a at the left and the second coding unit 1810b at the right in the horizontal direction. In this case, coding units may be determined in the same manner as when the first coding unit 1800 is split into four second coding units 1830a through 1830d having a square shape.

As another example, the image decoding apparatus 300 may determine third coding units 1822a and 1822b having a square shape by splitting the second coding unit 1820a at the top in a vertical direction, and determine third coding units 1824a and 1824b having a square shape by splitting the second coding unit 1820b at the bottom in a vertical direction. In addition, the image decoding apparatus 300 may determine third coding units 1826a through 1826d having a square shape by splitting both the second coding unit 1820a at the top and the second coding unit 1820b at the bottom in the vertical direction. In this case, coding units may be determined in the same manner as when the first coding unit 1800 is split into four second coding units 1830a through 1830d having a square shape.

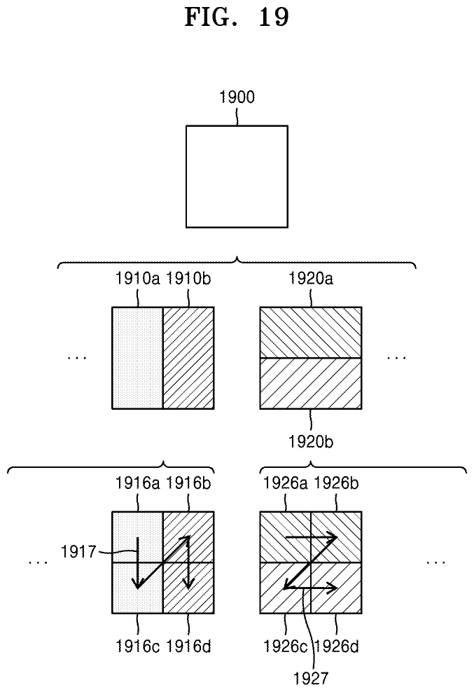

FIG. 19 illustrates that an order of processing a plurality of coding units may be changed according to processes of splitting a coding unit, according to an embodiment.

According to an embodiment, the image decoding apparatus 300 may split a first coding unit 1900 based on block shape information and split type information. When the block shape information indicates a square shape and the split type information indicates that the first coding unit 1900 is split in at least one of a horizontal direction and a vertical direction, the image decoding apparatus 300 may split the first coding unit 1900 to determine second coding units 1910a and 1910b, or 1920a and 1920b. Referring to FIG. 19, the second coding units 1910a and 1910b, or 1920a and 1920b having a non-square shape and determined when the first coding unit 1900 is split in the horizontal direction or the vertical direction may each be independently split based on block shape information and split type information. For example, the image decoding apparatus 300 may determine third coding units 1916a through 1916d by splitting, in the horizontal direction, each of the second coding units 1910a and 1910b generated as the first coding unit 1900 is split in the vertical direction, or determine third coding units 1926a through 1926d by splitting, in the horizontal direction, the second coding units 1920a and 1920b generated as the first coding unit 1900 is split in the horizontal direction. Processes of splitting the second coding units 1910a and 1910b, or 1920a and 1920b have been described above with reference to FIG. 17, and thus details thereof are not provided again.

According to an embodiment, the image decoding apparatus 300 may process coding units according to a certain order. Features about processing coding units according to a certain order have been described above with reference to FIG. 14, and thus details thereof are not provided again. Referring to FIG. 19, the image decoding apparatus 300 may determine four third coding units 1916a through 1916d or 1926a through 1926d having a square shape by splitting the first coding unit 1900 having a square shape. According to an embodiment, the image decoding apparatus 300 may determine an order of processing the third coding units 1916a through 1916d or 1926a through 1926d based on how the first coding unit 1900 is split.

According to an embodiment, the image decoding apparatus 300 may determine the third coding units 1916a through 1916d by splitting, in the horizontal direction, the second coding units 1910a and 1910b generated as the first coding unit 1900 is split in the vertical direction, and process the third coding units 1916a through 1916d according to an order 1917 of first processing, in the vertical direction, the third coding units 1916a and 1916b included in the second coding unit 1910a at the left, and then processing, in the vertical direction, the third coding units 1916c and 1916d included in the second coding unit 1910b at the right.

According to an embodiment, the image decoding apparatus 300 may determine the third coding units 1926a through 1926d by splitting, in the vertical direction, the second coding units 1920a and 1920b generated as the first coding unit 1900 is split in the horizontal direction, and process the third coding units 1926a through 1926d according to an order 1927 of first processing, in the horizontal direction, the third coding units 1926a and 1926b included in the second coding unit 1920a at the top, and then processing, in the horizontal direction, the third coding units 1926c and 1926d included in the second coding unit 1920b at the bottom.

Referring to FIG. 19, the third coding units 1916a through 1916d or 1926a through 1926d having a square shape may be determined when the second coding units 1910a and 1910b, or 1920a and 1920b are each split. The second coding units 1910a and 1910b determined when the first coding unit 1900 is split in the vertical direction and the second coding units 1920a and 1920b determined when the first coding unit 1900 is split in the horizontal direction are split in different shapes, but according to the third coding units 1916a through 1916d and 1926a through 1926d determined afterwards, the first coding unit 1900 is split in coding units having same shapes. Accordingly, the image decoding apparatus 300 may process pluralities of coding units determined in same shapes in different orders even when the coding units having the same shapes are consequently determined when coding units are recursively split through different processes based on at least one of block shape information and split type information.

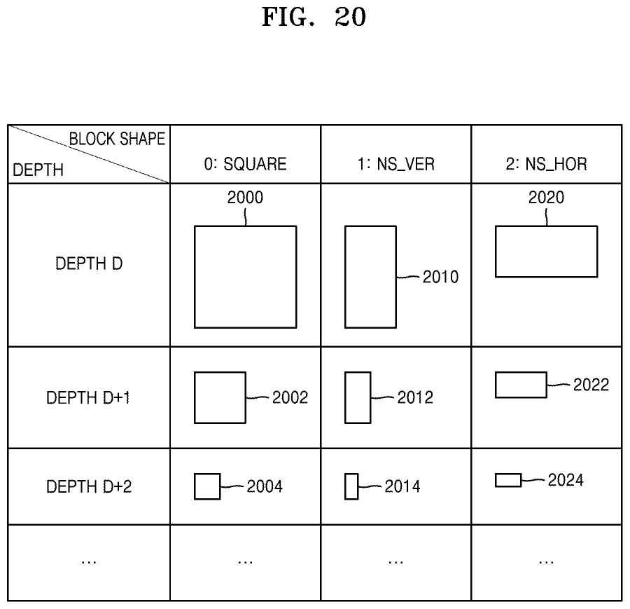

FIG. 20 illustrates processes of determining a depth of a coding unit as a shape and size of the coding unit are changed, when a plurality of coding units are determined when the coding unit is recursively split, according to an embodiment.

According to an embodiment, the image decoding apparatus 300 may determine a depth of a coding unit according to a certain standard. For example, the certain standard may be a length of a long side of the coding unit. When a length of a long side of a current coding unit is split 2n times shorter than a length of a long side of a coding unit before being split, it may be determined that a depth of the current coding unit is increased n times a depth of the coding unit before being split, wherein n>0. Hereinafter, a coding unit having an increased depth is referred to as a coding unit of a lower depth.

Referring to FIG. 20, the image decoding apparatus 300 may determine a second coding unit 2002 and a third coding unit 2004 of lower depths by splitting a first coding unit 2000 having a square shape, based on block shape information indicating a square shape (for example, block shape information may indicate ‘0:SQURE’), according to an embodiment. When a size of the first coding unit 2000 having a square shape is 2N×2N, the second coding unit 2002 determined by splitting a width and a height of the first coding unit 2000 by ½¹ may have a size of N×N. In addition, the third coding unit 2004 determined by splitting a width and a height of the second coding unit 2002 by ½ may have a size of N/2×N/2. In this case, a width and a height of the third coding unit 2004 corresponds to ½² of the first coding unit 2000. When a depth of first coding unit 2000 is D, a depth of the second coding unit 2002 having ½¹ of the width and the height of the first coding unit 2000 may be D+1, and a depth of the third coding unit 2004 having ½² of the width and the height of the first coding unit 2000 may be D+2.

According to an embodiment, the image decoding apparatus 300 may determine a second coding unit 2012 or 2022 and a third coding unit 2014 or 2024 by splitting a first coding unit 2010 or 2020 having a non-square shape, based on block shape information indicating a non-square shape (for example, block shape information may indicate ‘1:NS_VER’ indicating a non-square shape in which a height is longer than a width, or ‘2:NS_HOR’ indicating a non-square shape in which a width is longer than a height), according to an embodiment.

The image decoding apparatus 300 may determine a second coding unit (for example, the second coding unit 2002, 2012, or 2022) by splitting at least one of a width and a height of the first coding unit 2010 having a size of N×2N. In other words, the image decoding apparatus 300 may determine the second coding unit 2002 having a size of N×N or the second coding unit 2022 having a size of N×N/2 by splitting the first coding unit 2010 in a horizontal direction, or determine the second coding unit 2012 having a size of N/2×N by splitting the first coding unit 2010 in horizontal and vertical directions.

The image decoding apparatus 300 may determine a second coding unit (for example, the second coding unit 2002, 2012, or 2022) by splitting at least one of a width and a height of the first coding unit 2020 having a size of 2N×N. In other words, the image decoding apparatus 300 may determine the second coding unit 2002 having a size of N×N or the second coding unit 2012 having a size of N/2×N by splitting the first coding unit 2020 in a vertical direction, or determine the second coding unit 2022 having a size of N×N/2 by splitting the first coding unit 2010 in horizontal and vertical directions.

According to an embodiment, the image decoding apparatus 300 may determine a third coding unit (for example, the third coding unit 2004, 2014, or 2024) by splitting at least one of a width and a height of the second coding unit 2002 having a size of N×N. In other words, the image decoding apparatus 300 may determine the third coding unit 2004 having a size of N/2×N/2, the third coding unit 2014 having a size of N/2²×N/2, or the third coding unit 2024 having a size of N/2×N/2² by splitting the second coding unit 2002 in vertical and horizontal directions.

According to an embodiment, the image decoding apparatus 300 may determine a third coding unit (for example, the third coding unit 2004, 2014, or 2024) by splitting at least one of a width and a height of the second coding unit 2022 having a size of N/2×N. In other words, the image decoding apparatus 300 may determine the third coding unit 2004 having a size of N/2×N/2 or the third coding unit 2024 having a size of N/2×N/2² by splitting the second coding unit 2012 in a horizontal direction, or the third coding unit 2014 having a size of N/2²×N/2 by splitting the second coding unit 2012 in vertical and horizontal directions.

According to an embodiment, the image decoding apparatus 300 may determine a third coding unit (for example, the third coding unit 2004, 2014, or 2024) by splitting at least one of a width and a height of the second coding unit 2022 having a size of N×N/2. In other words, the image decoding apparatus 300 may determine the third coding unit 2004 having a size of N/2×N/2 or the third coding unit 2014 having a size of N/2²×N/2 by splitting the second coding unit 2022 in a vertical direction, or the third coding unit 2024 having a size of N/2×N/2² by splitting the second coding unit 2022 in vertical and horizontal directions.

According to an embodiment, the image decoding apparatus 300 may split a coding unit (for example, the first, second, or third coding unit 2000, 2002, or 2004) having a square shape in a horizontal or vertical direction. For example, the first coding unit 2010 having a size of N×2N may be determined by splitting the first coding unit 2000 having a size of 2N×2N in the vertical direction, or the first coding unit 2020 having a size of 2N×N may be determined by splitting the first coding unit 2000 in the horizontal direction. According to an embodiment, when a depth is determined based on a length of a longest side of a coding unit, a depth of a coding unit determined when the first coding unit 2000 having a size of 2N×2N is split in a horizontal or vertical direction may be the same as a depth of the first coding unit 2000.

According to an embodiment, the width and the height of the third coding unit 2014 or 2024 may be ½² of those of the first coding unit 2010 or 2020. When the depth of the first coding unit 2010 or 2020 is D, the depth of the second coding unit 2012 or 2022 that is ½ of the width and the height of the first coding unit 2010 or 2020 may be D+1, and the depth of the third coding unit 2014 or 2024 that is ½² of the width and the height of the first coding unit 2010 or 202 may be D+2.

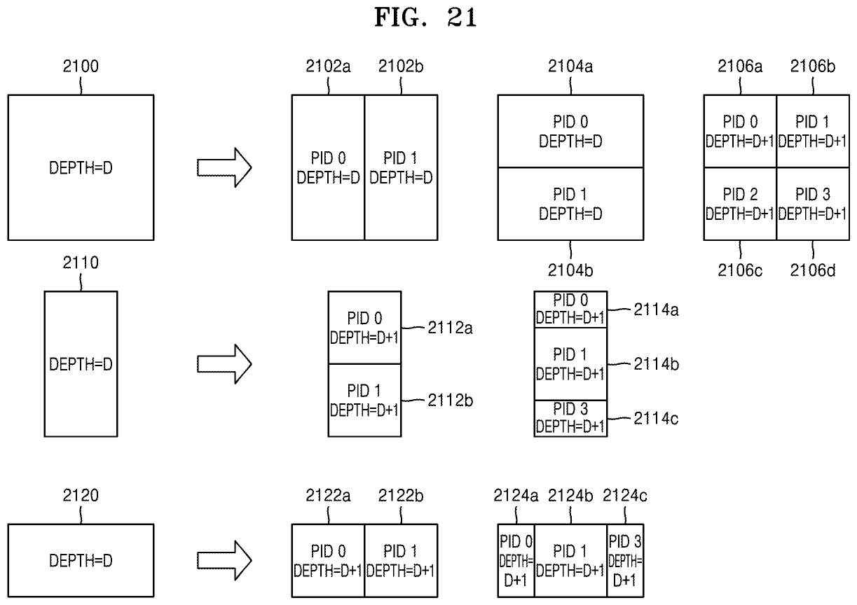

FIG. 21 illustrates a part index (PID) for distinguishing depths and coding units, which may be determined according to shapes and sizes of coding units, according to an embodiment.

According to an embodiment, the image decoding apparatus 300 may determine a second coding unit having various shapes by splitting a first coding unit 2100 having a square shape. Referring to FIG. 21, the image decoding apparatus 300 may determine second coding units 2102a and 2102b, 2104a and 2104b, or 2106a through 2106d by splitting the first coding unit 2100 in at least one of a vertical direction and a horizontal direction, according to split type information. In other words, the image decoding apparatus 300 may determine the second coding units 2102a and 2102b, 2104a and 2104b, or 2106a through 2106d based on split type information of the first coding unit 2100.

According to an embodiment, a depth of the second coding units 2102a and 2102b, 2104a and 2104b, or 2106a through 2106d determined according to the split type information of the first coding unit 2100 having a square shape may be determined based on a length of a long side. For example, since a length of one side of the first coding unit 2100 having a square shape is the same as a length of a long side of the second coding units 2102a and 2102b or 2104a and 2104b having a non-square shape, the depths of the first coding unit 2100 and the second coding units 2102a and 2102b or 2104a and 2104b having a non-square shape may be the same, i.e., D. On the other hand, when the image decoding apparatus 300 splits the first coding unit 2100 into the four second coding units 2106a through 2106d having a square shape, based on the split type information, a length of one side of the second coding units 2106a through 2106d having a square shape is ½ of the length of one side of the first coding unit 2100, the depths of the second coding units 2106a through 2106d may be D+1, i.e., a depth lower than the depth D of the first coding unit 2100.

According to an embodiment, the image decoding apparatus 300 may split a first coding unit 2110, in which a height is longer than a width, in a horizontal direction into a plurality of second coding units 2112a and 2112b or 2114a through 2114c, according to split type information. According to an embodiment, the image decoding apparatus 300 may split a first coding unit 2120, in which a width is longer than a height, in a vertical direction into a plurality of second coding units 2122a and 2122b or 2124a through 2124c, according to split type information.

According to an embodiment, depths of the second coding units 2112a and 2112b, 2114a through 2114c, 2122a and 2122b, or 2124a through 2124c determined according to the split type information of the first coding unit 2110 or 2120 having a non-square shape may be determined based on a length of a long side. For example, since a length of one side of the second coding units 2112a and 2112b having a square shape is ½ of a length of a long side of the first coding unit 2110 having a non-square shape, in which the height is longer than the width, the depths of the second coding units 2112a and 2112b are D+1, i.e., depths lower than the depth D of the first coding unit 2110 having a non-square shape.

In addition, the image decoding apparatus 300 may split the first coding unit 2110 having a non-square shape into an odd number of second coding units 2114a through 2114c, based on split type information. The odd number of second coding units 2114a through 2114c may include the second coding units 2114a and 2114c having a non-square shape, and the second coding unit 2114b having a square shape. In this case, since a length of a long side of the second coding units 2114a and 2114c having a non-square shape and a length of one side of the second coding unit 2114b having a square shape are ½ of a length of one side of the first coding unit 2110, depths of the second coding units 2114a through 2114b may be D+1, i.e., a depth lower than the depth D of the first coding unit 2110. The image decoding apparatus 300 may determine depths of coding units related to the first coding unit 2120 having a non-square shape in which a width is longer than a height, in the same manner as the determining of depths of coding units related to the first coding unit 2110.

According to an embodiment, with respect to determining PIDs for distinguishing coding units, when an odd number of coding units do not have the same size, the image decoding apparatus 300 may determine PIDs based on a size ratio of the coding units. Referring to FIG. 21, the second coding unit 2114b located at the center from the odd number of second coding units 2114a through 2114c may have the same width as the second coding units 2114a and 2114c, but have a height twice higher than those of the second coding units 2114a and 2114c. In this case, the second coding unit 2114b located at the center may include two of the second coding units 2114a and 2114c. Accordingly, when the PID of the second coding unit 2114b located at the center is 1 according to a scan order, the PID of the second coding unit 2114c in a next order may be 3, the PID having increased by 2. In other words, values of the PID may be discontinuous. According to an embodiment, the image decoding apparatus 300 may determine whether an odd number of coding units have the same sizes based on discontinuity of PID for distinguishing the coding units.

According to an embodiment, the image decoding apparatus 300 may determine whether a plurality of coding units determined when a current coding unit is split have certain split shapes based on values of PID. Referring to FIG. 21, the image decoding apparatus 300 may determine the even number of second coding units 2112a and 211b or the odd number of second coding units 2114a through 2114c by splitting the first coding unit 2110 having a rectangular shape in which the height is longer than the width. The image decoding apparatus 300 may use the PID indicating each coding unit so as to distinguish a plurality of coding units. According to an embodiment, a PID may be obtained from a sample at a certain location (for example, an upper left sample) of each coding unit.

According to an embodiment, the image decoding apparatus 300 may determine a coding unit at a certain location from among coding units determined by using PIDs for distinguishing coding units. According to an embodiment, when split type information of the first coding unit 2110 having a rectangular shape in which a height is longer than a width indicates that the first coding unit 2110 is split into three coding units, the image decoding apparatus 300 may split the first coding unit 2110 into the three second coding units 2114a through 2114c. The image decoding apparatus 300 may assign a PID to each of the three second coding units 2114a through 2114c. The image decoding apparatus 300 may compare PIDs of an odd number of coding units so as to determine a center coding unit from among the coding units. The image decoding apparatus 300 may determine, as a coding unit at a center location from among coding units determined when the first coding unit 2110 is split, the second coding unit 2114b having a PID corresponding to a center value from among PIDs, based on PIDs of the coding units. According to an embodiment, while determining PIDs for distinguishing coding units, when the coding units do not have the same sizes, the image decoding apparatus 300 may determine PIDs based on a size ratio of the coding units. Referring to FIG. 21, the second coding unit 2114b generated when the first coding unit 2110 is split may have the same width as the second coding units 2114a and 2114c, but may have a height twice higher than those of the second coding units 2114a and 2114c. In this case, when the PID of the second coding unit 2114b located at the center is 1, the PID of the second coding unit 2114c in a next order may be 3, the PID having increased by 2. As such, when an increasing range of PIDs differs while uniformly increasing, the image decoding apparatus 300 may determine that a current coding unit is split into a plurality of coding units including a coding unit having a different size from other coding units. According to an embodiment, when split type information indicates splitting into an odd number of coding units, the image decoding apparatus 300 may split a current coding unit into a plurality of coding units, in which a coding unit at a certain location (for example, a center coding unit) has a size different from other coding units. In this case, the image decoding apparatus 300 may determine the center coding unit having the different size by using PIDs of the coding units. However, a PID, and a size or location of a coding unit at a certain location described above are specified to describe an embodiment, and thus should not be limitedly interpreted, and various PIDs, and various locations and sizes of a coding unit may be used.

According to an embodiment, the image decoding apparatus 300 may use a certain data unit from which recursive splitting of a coding unit is started.

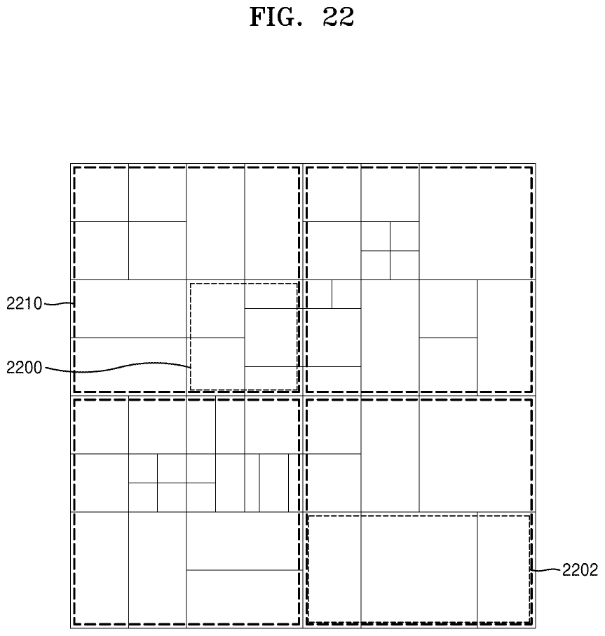

FIG. 22 illustrates that a plurality of coding units are determined according to a plurality of certain data units included in a picture, according to an embodiment.

According to an embodiment, a certain data unit may be defined as a data unit from which a coding unit starts to be recursively split by using at least one of block shape information and split type information. In other words, the certain data unit may correspond to a coding unit of an uppermost depth used while determining a plurality of coding units by splitting a current picture. Hereinafter, the certain data unit is referred to as a reference data unit for convenience of description.

According to an embodiment, the reference data unit may indicate a certain size and shape. According to an embodiment, the reference data unit may include M×N samples. Here, M and N may be the same, and may be an integer expressed as a multiple of 2. In other words, a reference data unit may indicate a square shape or a non-square shape, and may later be split into an integer number of coding units.

According to an embodiment, the image decoding apparatus 300 may split a current picture into a plurality of reference data units. According to an embodiment, the image decoding apparatus 300 may split the plurality of reference data units obtained by splitting the current picture by using split type information about each of the reference data units. Split processes of such reference data units may correspond to split processes using a quad-tree structure.

According to an embodiment, the image decoding apparatus 300 may pre-determine a smallest size available for the reference data unit included in the current picture. Accordingly, the image decoding apparatus 300 may determine the reference data unit having various sizes that are equal to or larger than the smallest size, and determine at least one coding unit based on the determined reference data unit by using block shape information and split type information.

Referring to FIG. 22, the image decoding apparatus 300 may use a reference coding unit 2200 having a square shape, or may use a reference coding unit 2202 having a non-square shape. According to an embodiment, a shape and size of a reference coding unit may be determined according to various data units (for example, a sequence, a picture, a slice, a slice segment, and a largest coding unit) that may include at least one reference coding unit.

According to an embodiment, the receiver 210 of the image decoding apparatus 300 may obtain, from a bitstream, at least one of information about a shape of a reference coding unit and information about a size of the reference coding unit, according to the various data units. Processes of determining at least one coding unit included in the reference coding unit 2200 having a square shape have been described above through processes of splitting the current coding unit 1000 of FIG. 10, and processes of determining at least one coding unit included in the reference coding unit 2200 having a non-square shape have been described above through processes of splitting the current coding unit 1100 or 1150 of FIG. 11, and thus details thereof are not provided again.

According to an embodiment, in order to determine a size and shape of a reference coding unit according to some data units pre-determined based on a predetermined condition, the image decoding apparatus 300 may use a PID for distinguishing the size and shape of the reference coding unit. In other words, the receiver 210 may obtain, from a bitstream, only a PID for distinguishing a size and shape of a reference coding unit as a data unit satisfying a predetermined condition (for example, a data unit having a size equal to or smaller than a slice) from among various data units (for example, a sequence, a picture, a slice, a slice segment, and a largest coding unit), according to slices, slice segments, and largest coding units. The image decoding apparatus 300 may determine the size and shape of the reference data unit according to data units that satisfy the predetermined condition, by using the PID. When information about a shape of a reference coding unit and information about a size of a reference coding unit are obtained from a bitstream and used according to data units having relatively small sizes, usage efficiency of the bitstream may not be sufficient, and thus instead of directly obtaining the information about the shape of the reference coding unit and the information about the size of the reference coding unit, only a PID may be obtained and used. In this case, at least one of the size and the shape of the reference coding unit corresponding to the PID indicating the size and shape of the reference coding unit may be pre-determined. In other words, the image decoding apparatus 300 may select at least one of the pre-determined size and shape of the reference coding unit according to the PID so as to determine at least one of the size and shape of the reference coding unit included in a data unit that is a criterion for obtaining the PID.

According to an embodiment, the image decoding apparatus 300 may use at least one reference coding unit included in one largest coding unit. In other words, a largest coding unit splitting an image may include at least one reference coding unit, and a coding unit may be determined when each of the reference coding unit is recursively split. According to an embodiment, at least one of a width and height of the largest coding unit may be an integer times at least one of a width and height of the reference coding unit. According to an embodiment, a size of a reference coding unit may be equal to a size of a largest coding unit, which is split n times according to a quad-tree structure. In other words, the image decoding apparatus 300 may determine a reference coding unit by splitting a largest coding unit n times according to a quad-tree structure, and split the reference coding unit based on at least one of block shape information and split type information according to various embodiments.

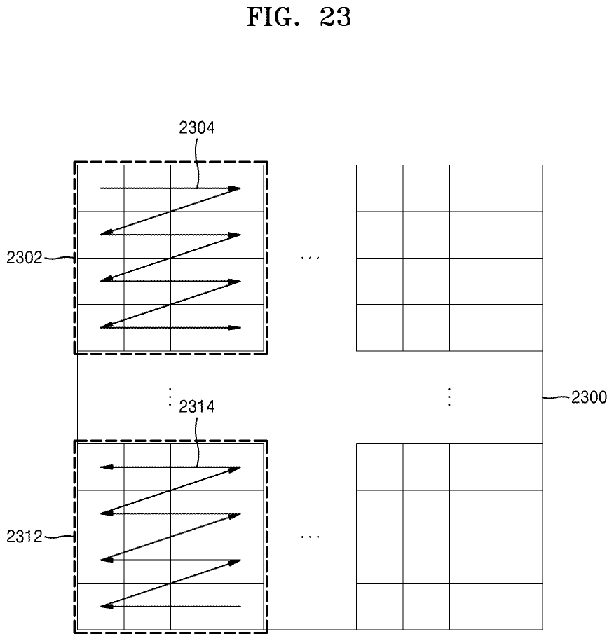

FIG. 23 illustrates a processing block serving as a criterion of determining a determination order of reference coding units included in a picture 2300, according to an embodiment.

According to an embodiment, the image decoding apparatus 300 may determine at least one processing block splitting a picture. A processing block is a data unit including at least one reference coding unit splitting an image, and the at least one reference coding unit included in the processing block may be determined in a certain order. In other words, a determining order of the at least one reference coding unit determined in each processing block may correspond to one of various orders for determining a reference coding unit, and may vary according to processing blocks. A determining order of reference coding units determined per processing block may be one of various orders, such as a raster scan order, a Z-scan order, an N-scan order, an up-right diagonal scan order, a horizontal scan order, and a vertical scan order, but should not be limitedly interpreted with respect to the scan orders.

According to an embodiment, the image decoding apparatus 300 may determine a size of at least one processing block included in an image by obtaining information about a size of a processing block. The image decoding apparatus 300 may obtain, from a bitstream, the information about a size of a processing block to determine the size of the at least one processing block included in the image. The size of the processing block may be a certain size of a data unit indicated by the information about a size of a processing block.

According to an embodiment, the receiver 210 of the image decoding apparatus 300 may obtain, from the bitstream, the information about a size of a processing block according to certain data units. For example, the information about a size of a processing block may be obtained from the bitstream in data units of images, sequences, pictures, slices, and slice segments. In other words, the receiver 210 may obtain, from the bitstream, the information about a size of a processing block according to such several data units, and the image decoding apparatus 300 may determine the size of at least one processing block splitting the picture by using the obtained information about a size of a processing block, wherein the size of the processing block may be an integer times a size of a reference coding unit.

According to an embodiment, the image decoding apparatus 300 may determine sizes of processing blocks 2302 and 2312 included in the picture 2300. For example, the image decoding apparatus 300 may determine a size of a processing block based on information about a size of a processing block, the information being obtained from a bitstream. Referring to FIG. 23, the image decoding apparatus 300 may determine horizontal sizes of the processing blocks 2302 and 2312 to be four times a horizontal size of a reference coding unit, and a vertical size thereof to be four times a vertical size of the reference coding unit, according to an embodiment. The image decoding apparatus 300 may determine a determining order of at least one reference coding unit in at least one processing block.

According to an embodiment, the image decoding apparatus 300 may determine each of the processing blocks 2302 and 2312 included in the picture 2300 based on a size of a processing block, and determine a determining order of at least one reference coding unit included in each of the processing blocks 2302 and 2312. According to an embodiment, determining of a reference coding unit may include determining a size of the reference coding unit.

According to an embodiment, the image decoding apparatus 300 may obtain, from a bitstream, information about a determining order of at least one reference coding unit included in at least one processing block, and determine the determining order of the at least one reference coding unit based on the obtained information. The information about a determining order may be defined as an order or direction of determining reference coding units in a processing block. In other words, an order of determining reference coding units may be independently determined per processing block.

According to an embodiment, the image decoding apparatus 300 may obtain, from a bitstream, information about a determining order of a reference coding unit according to certain data units. For example, the receiver 210 may obtain, from the bitstream, the information about a determining order of a reference coding unit according to data units, such as images, sequences, pictures, slices, slice segments, and processing blocks. Since the information about a determining order of a reference coding unit indicates a determining order of a reference coding unit in a processing block, the information about a determining order may be obtained per certain data unit including an integer number of processing blocks.

According to an embodiment, the image decoding apparatus 300 may determine at least one reference coding unit based on the determined order.

According to an embodiment, the receiver 210 may obtain, from the bitstream, information about a determining order of a reference coding unit, as information related to the processing blocks 2302 and 2312, and the image decoding apparatus 300 may determine an order of determining at least one reference coding unit included in the processing blocks 2302 and 2312 and determine at least one reference coding unit included in the picture 2300 according to a determining order of a coding unit. Referring to FIG. 23, the image decoding apparatus 300 may determine determining orders 2304 and 2314 of at least one reference coding unit respectively related to the processing blocks 2302 and 2312. For example, when information about a determining order of a reference coding unit is obtained per processing block, determining orders of a reference coding unit related to the processing blocks 2302 and 2312 may be different from each other. When the determining order 2304 related to the processing block 2302 is a raster scan order, reference coding units included in the processing block 2302 may be determined according to the raster scan order. On the other hand, when the determining order 2314 related to the processing block 2312 is an inverse order of a raster scan order, reference coding units included in the processing block 2312 may be determined in the inverse order of the raster scan order.

The image decoding apparatus 300 may decode determined at least one reference coding unit, according to an embodiment. The image decoding apparatus 300 may decode an image based on reference coding units determined through above embodiments. Examples of a method of decoding a reference coding unit may include various methods of decoding an image.

According to an embodiment, the image decoding apparatus 300 may obtain, from a bitstream, and use block shape information indicating a shape of a current coding unit or split type information indicating a method of splitting the current coding unit. The block shape information or the split type information may be included in a bitstream related to various data units. For example, the image decoding apparatus 300 may use the block shape information or split type information, which is included in a sequence parameter set, a picture parameter set, a video parameter set, a slice header, and a slice segment header. In addition, the image decoding apparatus 300 may obtain, from a bitstream, and use syntax corresponding to the block shape information or the split type information, according to largest coding units, reference coding units, and processing blocks.

While this disclosure has been particularly shown and described with reference to embodiments thereof, it will be understood by those of ordinary skill in the art that various changes in form and details may be made therein without departing from the spirit and scope of the disclosure as defined by the appended claims. The embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

The embodiments of the present disclosure can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

1. An image decoding method comprising:
receiving an encoded bitstream;
obtaining information regarding an intra-prediction mode of a current block from the bitstream;
determining a filter, based on a signal component of the current block, a width and height of the current block, and a value of at least one among reference samples neighboring the current block;
producing filtered reference samples by applying the filter to the reference samples; and
producing a predicted sample of the current block, based on the filtered reference samples and the intra-prediction mode.

2. The image decoding method of claim 1, wherein a block shape of the current block comprises a non-square shape.

3. The image decoding method of claim 1, wherein the producing of the filtered reference samples comprises:
when the filter is a strong filter, performing bi-linear filtering on the reference samples in a horizontal direction and a vertical direction; and
when the filter is a weak filter, performing smoothing filtering on the reference samples in the horizontal direction and the vertical direction.

4. The image decoding method of claim 1, wherein the determining of the filter comprises determining the filter to be a strong filter when the width and height of the current block are each greater than or equal to a certain value.

5. The image decoding method of claim 1, wherein the determining of the filter comprises determining the filter to be a strong filter when the sum of the width and height of the current block is greater than or equal to a certain value.

6. The image decoding method of claim 1, wherein the determining of the filter comprises determining the filter to be a strong filter when a larger value among the width and height of the current block is greater than or equal to a certain value.

7. The image decoding method of claim 1, wherein the determining of the filter comprises determining the filter to be a strong filter when a smaller value among the width and height of the current block is greater than or equal to a certain value.

8. The image decoding method of any one of claims 4 to 7, wherein the certain value is determined by a size of a largest coding unit.

9. The image decoding method of any one of claims 4 to 7, wherein the certain value is determined by a maximum size of a transform unit.

10. The image decoding method of claim 1, further comprising determining whether filtering is to be performed, based on the intra-prediction mode and the width and height of the current block.

11. An image decoding device comprising:
a receiver configured to receive an encoded bitstream; and
a decoder configured to obtain information regarding an intra-prediction mode of a current block from the bitstream, determine a filter based on a signal component of the current block, a width and height of the current block, and a value of at least one among reference samples neighboring the current block, produce filtered reference samples by applying the filter to the reference samples, and produce a predicted sample of the current block, based on the filtered reference samples and the intra-prediction mode.

12. The image decoding device of claim 11, wherein a block shape of the current block comprises a non-square shape.

13. The image decoding device of claim 11, wherein the decoder determines the filter to be a strong filter when the width and height of the current block are each greater than or equal to a certain value.

14. The image decoding device of claim 11, wherein the decoder determines the filter to be a strong filter when the sum of the width and height of the current block is greater than or equal to a certain value.

15. An image encoding method comprising:
determining an intra-prediction mode of a current block;
determining a filter, based on a signal component of the current block, a width and height of the current block, and a value of at least one of reference samples neighboring the current block;
producing filtered reference samples by applying the filter to the reference samples;
producing a predicted sample of the current block, based on the filtered reference samples and the intra-prediction mode; and
encoding information regarding the intra-prediction mode.
